(19) United States
(12) Patent Application Publication
(10) Pub. No.: US 2007/0289843 A1
(43) Pub. Date: Dec. 20, 2007

(54) Conveyor System Including Offset Section

(76) Inventors: Barry Kitazumi, Milpitas, CA (US); Michael D. Brain, Monte Sereno, CA (US); Mihir Parikh, Los Altos Hills, CA (US)

Correspondence Address: CARR & FERRELL LLP, 2200 GENG ROAD, PALO ALTO, CA, 94303, US

(21) Appl. No.: 11/764,755

(22) Filed: Jun. 18, 2007

Related U.S. Application Data
(63) Continuation-in-part of application No. 11/406,569, filed on Apr. 18, 2006, now Pat. No. 7,281,623.
(60) Provisional application No. 60/805,084, filed on Jun. 18, 2006.
(60) Provisional application No. 60/840,169, filed on Aug. 25, 2006.
(60) Provisional application No. 60/805,085, filed on Jun. 18, 2006.

(51) Int. Cl. B65G 49/07; B65G 47/00

(52) U.S. Cl. 198/457.03

(57) ABSTRACT

A transport system for conveying articles along conveyance paths including straight, curvilinear, horizontal, inclined, and declined conveyance sections optionally physically offset from one another. The articles are conveyed between a pair of horizontal belts, vertical rollers, or vertical belts while being supported by protrusions extending from the horizontal belts, vertical rollers, or vertical belts. The vertical belts are guided using a multiplicity of vertical rollers that are configurable into straight, curvilinear, and dynamically changing conveyance sections. Multiple conveyance sections can be joined end to end to transport articles over complex paths and over long distances. The articles conveyed may include semiconductor wafers.

### CROSS-REFERENCE TO RELATED APPLICATIONS

This application is a continuation-in-part of co-pending U.S. application Ser. No. 11/406,569 entitled “Transport System Including Vertical Rollers” and filed on Apr. 18, 2006;

this application also claims the benefit of U.S. Provisional Application No. 60/805,084 entitled “Pulley and Belt Profiles for Transport System Including Vertical Rollers” and filed on Jun. 18, 2006;

this application also claims the benefit of U.S. Provisional Application No. 60/840,169 entitled “High Speed Transporter Including Horizontal Belt” and filed on Aug. 25, 2006;

this application also claims the benefit of U.S. Provisional Application No. 60/805,085 entitled “High Capacity Delivery with Priority Handling” and filed on Jun. 18, 2006.

The disclosures of all of the above provisional and nonprovisional patent applications are hereby incorporated herein by reference.

### BACKGROUND OF THE INVENTION

1. Field of the Invention

The current invention relates to transport systems and methods for conveying articles along a conveyance path, and in some embodiments to conveying semiconductor wafers in a semiconductor fabrication facility.

2. Related Art

Transport systems are widely employed in industrial manufacturing facilities to convey articles between work stations. Originally, these systems were manual and workers moved articles by hand or by cart. Modern factories have developed specialized equipment to convey articles automatically. In particular, semiconductor fabrication facilities currently use automated transport systems to move semiconductor wafers during the manufacturing process. Typically, a batch of wafers may be conveyed together in a container known as a Front Opening Unified Pod (FOUP). Semiconductor wafer manufacturers have sought to increase manufacturing productivity by using transport systems that efficiently convey wafers from machine to machine without exposing the wafers to excessive contamination, vibration or to excessive acceleration and deceleration forces.

Existing transport systems employ vehicle-based devices to eliminate vibrations but the capacity of this system is limited by the number of vehicles available. To resolve this, transporters are used in which articles are, for example, directly conveyed across the horizontal surface of a transport belt on rollers, or directly on the rollers. One such transport system is shown in FIG. 1A. A common feature of these existing systems is the difficulty of vibrationally isolating the article being conveyed from the surface across which the articles travel. If the surface across which the articles travel is not flat, the articles experience vibration during the conveyance. This source of vibration is a known problem in the semiconductor wafer manufacturing industry. For example, as shown in FIG. 1A, Horizontal Rollers 110 include Circular Surfaces 120 on which a Horizontal Belt 130 rests. Horizontal Belt 130 may be characterized by a Length 140, a Long Cross-Sectional Axis 150, and a Short Cross-Sectional Axis 160. The Long Cross-Sectional Axis 150 and a Short Cross-Sectional Axis 160 are perpendicular to the length, and disposed in horizontal and vertical planes, respectively. The weight of a FOUP 170 is transferred through the Short Cross-Sectional Axis 160 of Horizontal Belt 130 onto Circular Surfaces 120, as is shown in FIG. 1B. Because Horizontal Belt 130 is flexible in the Short Cross-Sectional Axis 160 in which the weight of FOUP 170 is applied and is not continuously supported by Horizontal Rollers 110, the level of Horizontal Belt 130 varies between Horizontal Rollers 110. This unevenness limits the speed at which FOUP 170 can be conveyed while staying within vibration limits.

Another problem with existing transport systems used in the semiconductor wafer manufacturing industry is the difficulty of changing or turning the direction of conveyance of an article, such as a FOUP, without momentarily stopping its motion.

There are, therefore, needs for improved systems and methods for conveying articles in manufacturing facilities.

### SUMMARY OF THE INVENTION

The present invention includes, in various embodiments, a transport system for moving articles along a conveyance path that includes straight, curvilinear, horizontal, inclined, and/or declined sections. The articles are conveyed between essentially vertical rollers that have circular surfaces that rotate to provide motion in a conveyance direction. Vertically-oriented belts are optionally disposed between the vertical rollers and the articles. In some embodiments, the vertical belts include a long cross-sectional axis approximately parallel to the vertical plane and a short cross-sectional axis approximately perpendicular to an axis of rotation of the vertical rollers. The weight of the articles transported is supported in a direction parallel to the vertical axis. As such, the weight is directed approximately parallel to a vertical rotational axis of the vertical rollers and need not be supported by the circular surfaces of the vertical rollers. This configuration allows the weight of the articles to be decoupled from the uneven circular surfaces.

In those embodiments including vertical belts, the weight of articles transported is optionally further supported through the long cross-sectional axis of the vertical belts. For example, the vertical belts are optionally stiffer through the weight bearing long cross-sectional axis than they are through their short cross-sectional axis. This results in less variation in the height of the vertical belt between support points (e.g., rollers), as compared to the height of a horizontal belt of the prior art. Systems of the invention, therefore, typically included reduced unevenness in the conveyance path relative to the prior art. In various embodiments, this reduced unevenness allows articles, such as FOUPs including semiconductor wafers, to be transported at greater speeds than in the prior art while still staying within vibration limits.

In various embodiments, articles are supported between first and second vertical belts by one or more support protrusions extending from the first vertical belt and second vertical belt. The weight of the articles is transferred through the support protrusions to the vertical belt. In various embodiments, the support protrusions, vertical belts, and vertical rollers are configured to selectively engage and disengage the articles. In some embodiments, the support protrusions are specifically configured to support FOUPs used to transport semiconductor wafers within semiconductor fabrication facilities.

A transport system optionally includes several transport sections each including separate vertical belts and/or separate sets of vertical rollers. Within an individual transport section, the vertical rollers are optionally configured in a curvilinear path, allowing an article to remain in motion as it is conveyed along a curved conveyance path. Further, within an individual transport section, the vertical rollers are optionally configured in an inclined or declined path, allowing the height of the article to be changed. In embodiments not including vertical belts, articles are typically transported by direct contact with vertical rollers.

Various embodiments of the invention include an offset system configured to change a direction of conveyance of an article such as a FOUP. In some embodiments the offset system comprises a first straight conveyance section delimiting a first straight conveyance path, an offset section delimiting an offset conveyance path disposed at an angle greater than 0 degrees from an angle of the first conveyance path, and a second straight conveyance section delimiting a second straight conveyance path disposed at an angle whose absolute value is greater than 0 degrees from an angle of the offset conveyance path. In some embodiments, the offset section comprises one or more straight and/or curvilinear conveyance sections. In some embodiments, an angle of a conveyance path within the offset section relative to the first straight conveyance path varies between an entrance of the offset section and an exit of the offset section. In various embodiments, the offset section comprises vertical rollers, vertical belts, horizontal rollers, and/or horizontal belts.

Various embodiments of the invention include a system comprising a first belt and a second belt disposed on either side of a conveyance path and configured to convey an article along the conveyance path, a plurality of vertical rollers configured to guide the first belt and the second belt, and a plurality of support protrusions extending from the first belt and from the second belt, the plurality of support protrusions configured to support a weight of the article.

Various embodiments of the invention include a transport belt comprising a first surface configured to be coupled to a vertical roller, the vertical roller being configured to drive the transport belt in a conveyance path, a support protrusion configured to support the weight of an article being conveyed along the conveyance path by the transport belt, and a compliant material configured to allow the support protrusion to move in response to forces from the article, and thus allow the transport belt to operate as a shock absorber.

Various embodiments of the invention include a method comprising loading an article on a conveyance section, the conveyance section including a first belt and a second belt and a plurality of vertical rollers configured to guide the first vertical belt and the second vertical belt, conveying the article along a conveyance path using the first vertical belt and the second vertical belt, and unloading the article.

Various embodiments of the invention include a system comprising a first conveyance section comprising a first belt disposed on a first side of a first conveyance path and a second belt disposed on second side of the first conveyance path, the first belt and the second belt configured to convey an article along the first conveyance path, a second conveyance section configured to receive the article from the first conveyance section and comprising a third belt disposed on a first side of a curved conveyance path and a fourth belt disposed on second side of the curved conveyance path, the third belt and the fourth belt configured to convey the article along the curved conveyance path, the second conveyance section further comprising a plurality of support protrusions attached to the third belt and the fourth belt and configured to support the article, and a third conveyance section configured to receive the article from the second conveyance section and comprising a fifth belt disposed on a first side of a second conveyance path and a sixth belt disposed on second side of the second conveyance path, the fifth belt and the sixth belt configured to convey the article along the second conveyance path.

Various embodiments of the invention include a system comprising a first conveyance section comprising a first belt disposed on a first side of a first conveyance path and a second belt disposed on second side of the first conveyance path, the first belt and the second belt configured to convey an article along the first conveyance path, a second conveyance section configured to receive the article from the first conveyance section and comprising one or more transition wheels disposed on one or both sides of a conveyance path and configured to change a direction of travel of the article along the conveyance path, the one or more transitions wheels including support protrusions configured to support the article, and a third conveyance section configured to receive the article from the second conveyance section and comprising a third belt disposed on a first side of a second conveyance path and a fourth belt disposed on second side of the second conveyance path, the third belt and the fourth belt configured to convey the article along the second conveyance path.

Various embodiments of the invention include a system comprising a first conveyance section configured to receive an article and comprising a first belt disposed on a first side of a curved conveyance path and a second belt disposed on second side of the curved conveyance path, the first belt and the second belt configured to convey the article along the curved conveyance path, the first conveyance section further comprising a plurality of support protrusions attached to the first belt and the second belt and configured to support the article.

Various embodiments of the invention include a method comprising conveying an article in a first conveyance section, the first conveyance section comprising a first belt disposed on a first side of a first conveyance path and a second belt disposed on second side of the first conveyance path, the first belt and the second belt configured to convey an article along the first conveyance path, turning the article in a second conveyance section, the second conveyance section configured to receive the article from the first conveyance section and comprising a third belt disposed on a first side of a curved conveyance path and a fourth belt disposed on second side of the curved conveyance path, the third belt and the fourth belt configured to convey the article along the curved conveyance path, the second conveyance section further comprising a plurality of support protrusions attached to the third belt and the fourth belt and configured to support the article, and conveying the article in a third conveyance section, the third conveyance section configured to receive the article from the second conveyance section and comprising a fifth belt disposed on a first side of a second conveyance path and a sixth belt disposed on second side of the second conveyance path, the fifth belt and the sixth belt configured to convey the article along the second conveyance path.

Various embodiments of the invention include a semiconductor article, display device, photovoltaic device, or memory device manufactured using the methods disclosed herein.

### BRIEF DESCRIPTION OF THE DRAWINGS

For a more complete understanding of the present invention and for further features and advantages, reference is made to the following description taken in conjunction with the accompanying drawings, in which:

FIG. 1A is a perspective view of a prior art transport system;

FIG. 1B is a portion of FIG. 1A, enlarged for magnification purposes;

FIG. 2A illustrates a transport section including a vertical belt, according to various embodiments of the invention;

FIG. 2B is a portion of FIG. 2A, enlarged for magnification purposes;

FIG. 2C illustrates the orientation of a vertical belt with respect to horizontal and vertical axes;

FIG. 3 illustrates a top view of the transport section of FIG. 2A, according to various embodiments of the invention;

FIGS. 4A, 4B, 4C, 4D, 4E, and 4F illustrate cross-sectional views of a vertical belt and a vertical roller, according to various alternative embodiments of the invention;

FIG. 5 illustrates an embodiment of a transport system including a transport section configured to form a curvilinear conveyance path, according to various embodiments of the invention;

FIGS. 6A and 6B illustrate embodiments of a transport system in two different dynamically interchangeable states, according to various embodiments of the invention;

FIGS. 7A, 7B, 7C and 7D illustrate cross-sectional views of a vertical belt in different dynamically interchangeable states, according to various embodiments of the invention;

FIGS. 8A and 8B illustrate transport sections in which a first vertical belt and second vertical belt are moved apart in order to load or unload an article, according to various embodiments of the invention;

FIG. 9 illustrates an offset section disposed between a first transport section and a second transport section, according to various embodiments of the invention;

FIG. 10 illustrates transition wheels, according to various embodiments of the invention;

FIGS. 11A and 11B illustrate alternative embodiments of an offset section;

FIG. 12 illustrates a support structure for the offset section according to various embodiments of the invention;

FIG. 13 illustrates methods of conveying articles, according to various embodiments of the invention;

FIG. 14 illustrates methods of dynamically changing a conveyance path, according to various embodiments of the invention; and

FIG. 15 illustrates methods of changing the conveyance path of articles, according to various embodiments of the invention.

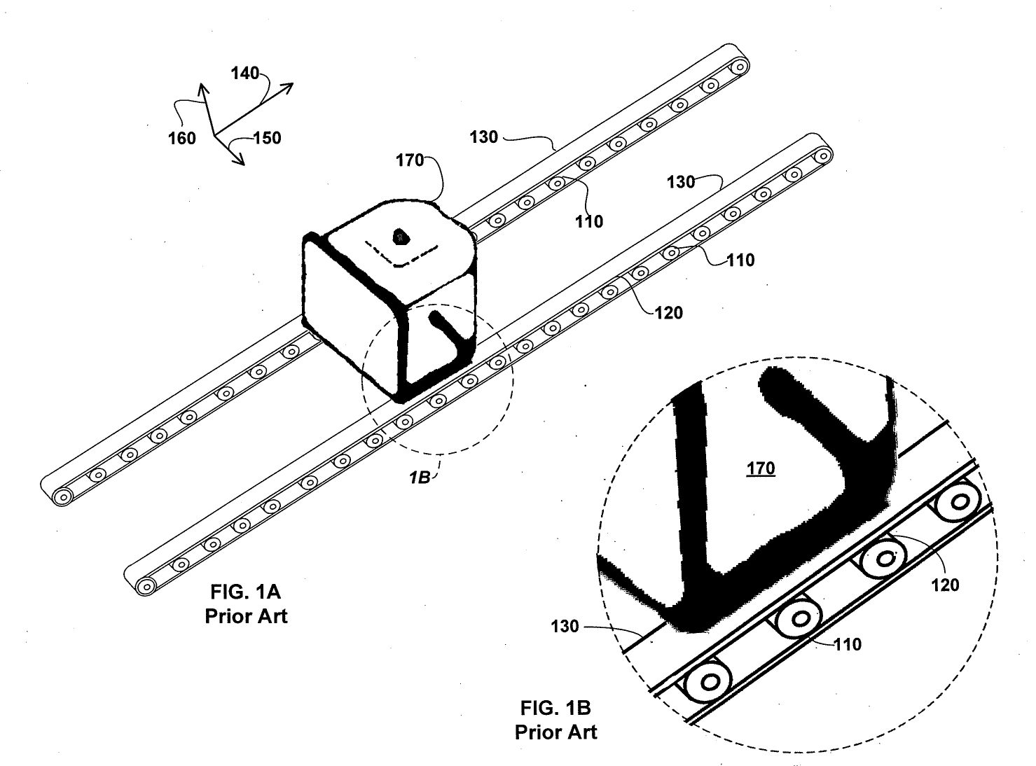

### DETAILED DESCRIPTION OF THE INVENTION

Various embodiments of the invention include improved systems and methods for automatically transporting articles such as FOUPs. For example, some embodiments include the use of vertical rollers to propel articles in a conveyance direction. In comparison with the prior art, the use of vertical rollers allows for more even support of articles and, thus, improved vibration management. In various embodiments, the use of vertical rollers allows the transport of articles along straight, inclined, declined, curvilinear (e.g., curved), and/or dynamically changing conveyance paths.

Vertical belts (transport belts) are optionally disposed between the vertical rollers and articles to be transported. In some embodiments, the vertical belts are configured to support the weight of the articles through a long vertical cross-sectional axis, as opposed to a short cross-sectional axis as in the prior art. By supporting the weight through the long cross-sectional axis, a more rigid, and thus more even, support can be provided as compared to systems in which support is provided through the short cross-sectional axis. In some embodiments, this more even support is used to transport articles at greater speeds than with prior art systems, while staying within vibration limits. In some embodiments, the vertical belts include a compliant material configured to reduce vibration of articles during transport.

In various embodiments, articles are supported by protrusions extending approximately horizontally from the vertical belts. In these embodiments, the weight of articles is transferred from the support protrusions through a long cross-sectional axis of a vertical belt. The support protrusions are optionally configured for supporting specific types of articles. For example, some embodiments include support protrusions configured for supporting a FOUP. The size and spacing of the support protrusions is optionally configured such that more than one protrusion from each vertical belt provides support to an article. In some instances, the support protrusions include a low friction material such as Teflon™ that will allow an article to move slightly on the support protrusions. In some embodiments, the support protrusions include a high friction material that reduces slippage during high acceleration and/or deceleration.

In various embodiments, the vertical belts include a compliant material configured to flex, deform, bend, or otherwise change shape when an article is placed on the support protrusions. This compliant material may have shock absorbing properties and may act to reduce the effects of irregularity of the surfaces of the article being conveyed. For example, in some embodiments the compliant materials are configured to allow a support protrusion to move vertically when supporting the weight of a FOUP.

In various embodiments, the vertical belts are supported by a low friction sliding surface, an array of finely spaced horizontal rollers, a support lip of a vertical roller, or the like. In some embodiments, the vertical belts are configured to fit partially within a v-groove or notch within a vertical roller and are supported by surfaces within this v-groove or notch.

Some embodiments include a retaining lip configured to restrain movement of articles relative to the transport system. This retaining lip may be part of a support protrusion, be a separate protrusion coupled to a vertical belt, or be attached to a stationary supporting structure. The retaining lip is optionally configured to restrain a FOUP and, thus, prevent tipping during acceleration and deceleration.

Conveyance paths determined by the location of vertical rollers and/or vertical belts may be straight, curvilinear, inclined, declined, and/or dynamically variable. For example, in some embodiments, vertical rollers are coupled to movable mounts and are configured to move between various different positions in order to change a conveyance path. In some embodiments, vertical rollers are configured to move while conveying articles.

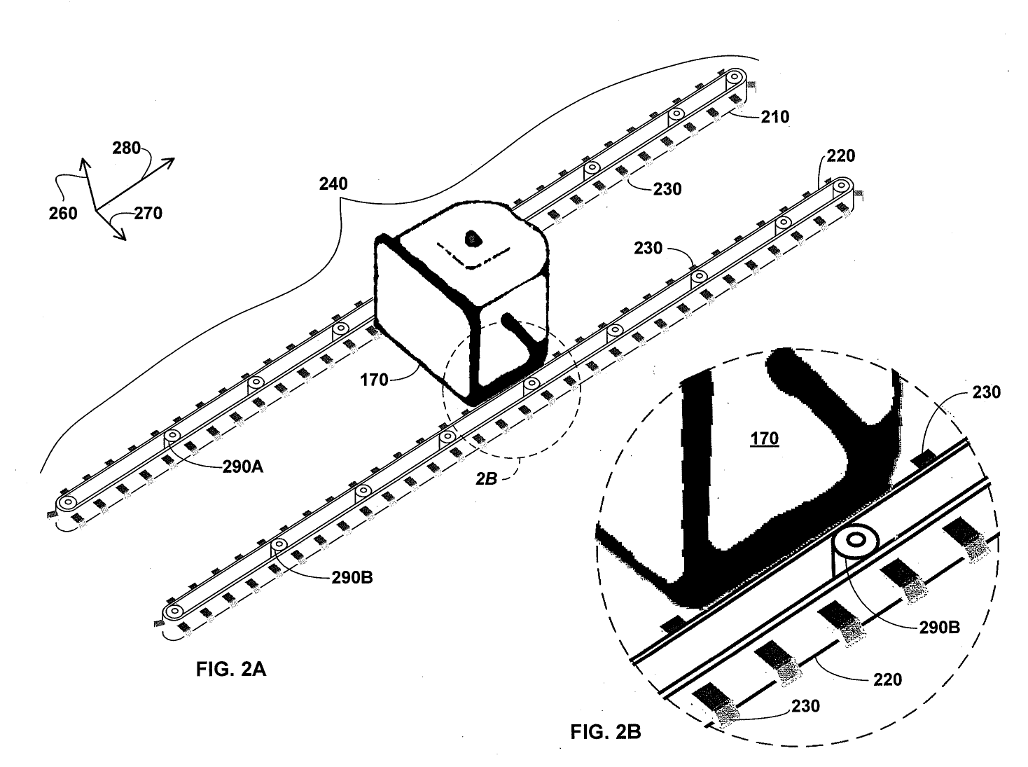

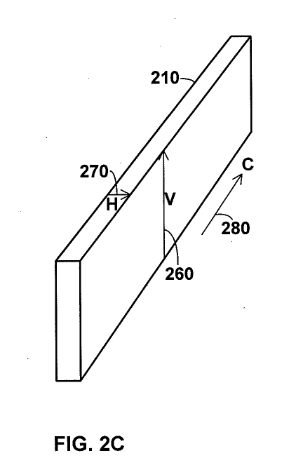

FIG. 2A illustrates a Transport Section generally designated 240 and including a First Vertical Belt 210, a Second Vertical Belt 220, and optional Support Protrusions 230. Transport Section 240 is configured to convey an article such as FOUP 170 and may be configured with multiple instances of separate Transport Sections 240. First Vertical Belt 210 and Second Vertical Belt 220 are optional in some embodiments.

First Vertical Belt 210 and Second Vertical Belt 220 optionally include a material that is stiff along a Vertical Axis 260 and less stiff in a Horizontal Axis 270. Vertical Axis 260 is parallel to a long cross-sectional axis of First Vertical Belt 210 and Horizontal Axis 270 is parallel to a short cross-sectional axis of First Vertical Belt 210. The long cross-sectional axis and short cross-sectional axis are perpendicular to a length of First Vertical Belt 210, which is, in turn, parallel to a Conveyance Direction 280. In typical embodiments, the weight of FOUP 170 is supported in the direction of Vertical Axis 260 and, thus, through the stiffer long cross-sectional axis of First Vertical Belt 210.

First Vertical Belt 210 and Second Vertical Belt 220 are each driven separately or jointly in the Conveyance Direction 280 by a plurality of Vertical Rollers 290A and a plurality of Vertical Rollers 290B, respectively. Vertical Rollers 290A are spaced apart from Vertical Rollers 290B such that FOUP 170 may be supported between that First Vertical Belt 210 and Second Vertical Belt 220. The paths along which Vertical Rollers 290A and Vertical Rollers 290B are disposed define a conveyance path through which FOUP 170 will travel. Through selective placement of Vertical Rollers 290A and Vertical Rollers 290B, straight or curvilinear conveyance paths may be defined. Using a variety of transport sections, such as a multiplicity of Transport Section 240, a FOUP 170 can be transported along a complex variety of conveyance paths. Typically, at each end of a transport section, First Vertical Belt 210 and Second Vertical Belt 220 wrap around an instance of Vertical Rollers 290A and Vertical Rollers 290B, respectively. This is possible because First Vertical Belt 210 and Second Vertical Belt 220 are flexible in Horizontal Axis 270.

In typical embodiments, one or more Support Protrusions 230 are attached to each of First Vertical Belt 210 and to Second Vertical Belt 220. Support Protrusions 230 extend from First Vertical Belt 210 and from Second Vertical Belt 220, and are optionally configured such that the weight of conveyed articles is supported through the long cross-sectional axes of First Vertical Belt 210 and Second Vertical Belt 220. FIG. 2B is a portion of FIG. 2A, enlarged to show further detail of FOUP 170, Second Vertical Belt 220, Support Protrusions 230 and one of Vertical Rollers 290B. As First Vertical Belt 210 and Second Vertical Belt 220 are driven (moved) by Vertical Rollers 290A and Vertical Rollers 290B, articles resting on Support Protrusions 230 are carried along Transport Section 240 in Conveyance Direction 280.

FIG. 2C illustrates, in further detail, the relationship between First Vertical Belt 210 and Vertical Axis 260, Horizontal Axis 270, and Conveyance Direction 280.

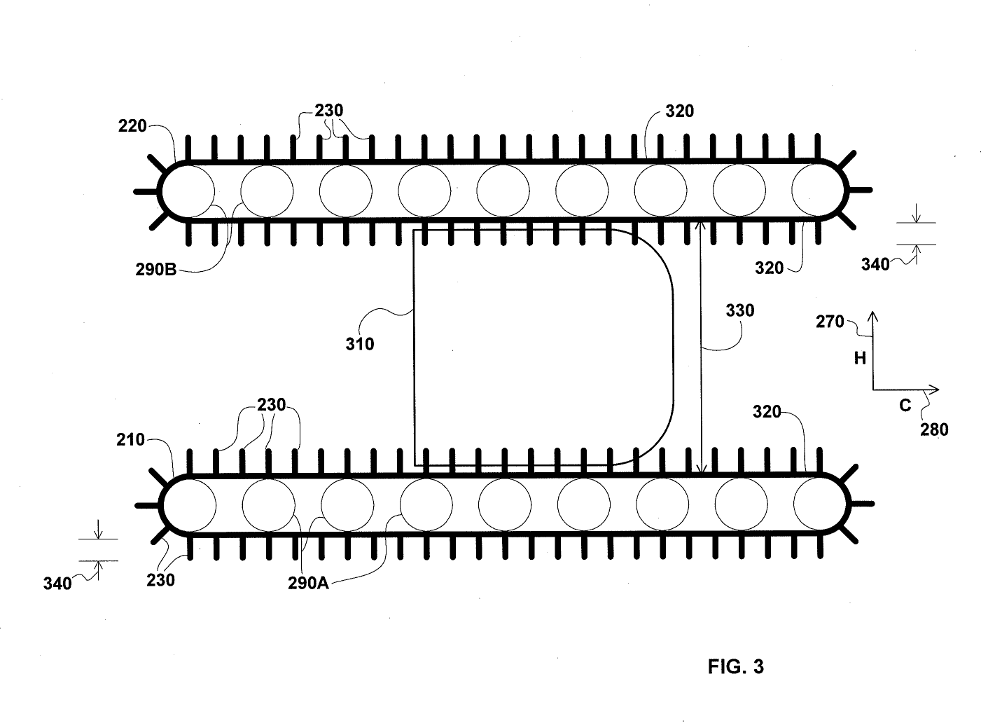

FIG. 3 illustrates a top view of Transport Section 240. This view illustrates how FOUP 170, illustrated by Outline 310, is laterally confined (in Horizontal Axis 270) by First Vertical Belt 210 and Second Vertical Belt 220, and Vertical Rollers 290A and Vertical Rollers 290B. In various embodiments, Vertical Surfaces 320 of First Vertical Belt 210 and Second Vertical Belt 220 are separated by a Distance 330 equal to or less than 390, 415, or 500 millimeter (mm). Thus, an instance of FOUP 170 that is, for example, 390 mm wide has less than zero, 25, or 110 mm of lateral freedom of movement, or greater than zero, 25, or 110 mm of lateral freedom of movement. Some embodiments of the invention include a three-point kinematic interface (as shown elsewhere herein) configured for locating a FOUP within this freedom of movement when the FOUP is unloaded from Transport Section 240.

FIG. 3 also illustrates how FOUP 170, illustrated by Outline 310, rests on Support Protrusions 230. In various embodiments, Support Protrusions 230 extend a Distance 340 equal to or less than 10, 50, or 100 mm from Vertical Surfaces 320. In various embodiments, Support Protrusions 230 extend under FOUP 170 by distances equal to or greater than 10, 50, or 100 mm.

Support Protrusions 230 attached to First Vertical Belt 210 may be separated from each other by a variety of distances. For example, in instances of Transport Section 240 configured to transport FOUP 170 along a straight conveyance path, Support Protrusions 230 may be further apart than in an instance of Transport Section 240 configured to transport FOUP 170 in a curvilinear conveyance path. In various embodiments, instances of Support Protrusions 230 attached to First Vertical Belt 210 are disposed equal to or less than 10, 30, or 100 mm from each other. In one embodiment, Support Protrusions 230 are in contact with each other. In this embodiment, Support Protrusions 230 form an essentially continuous support.

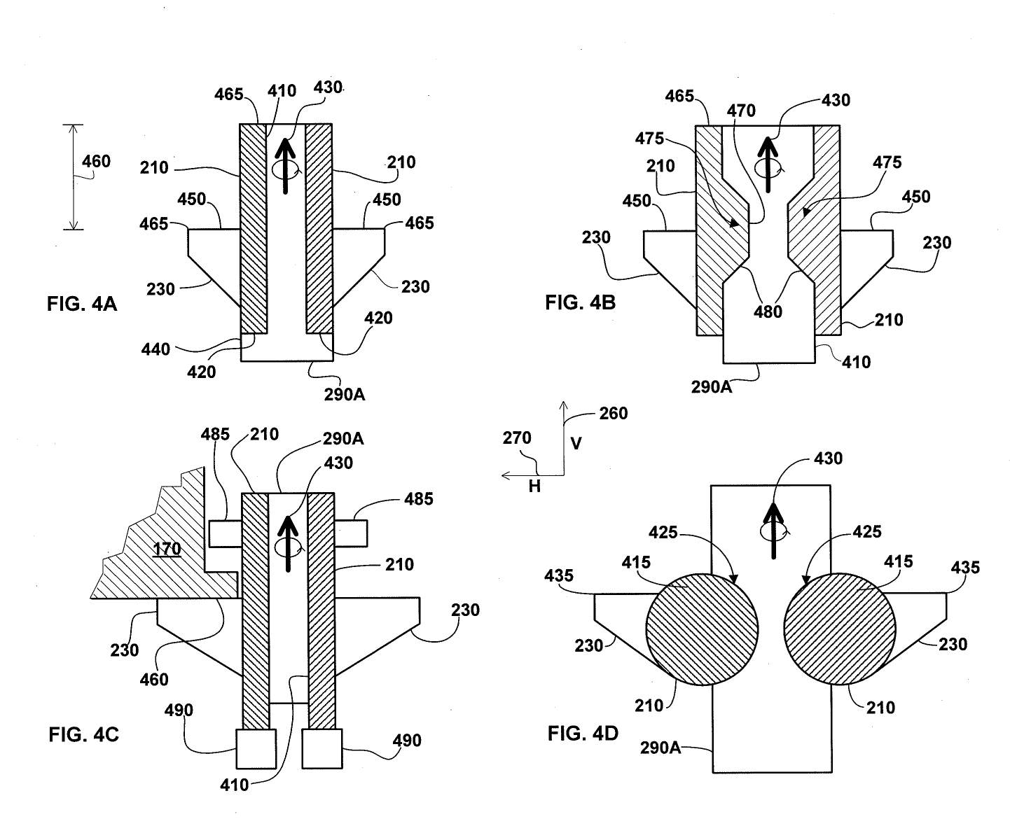

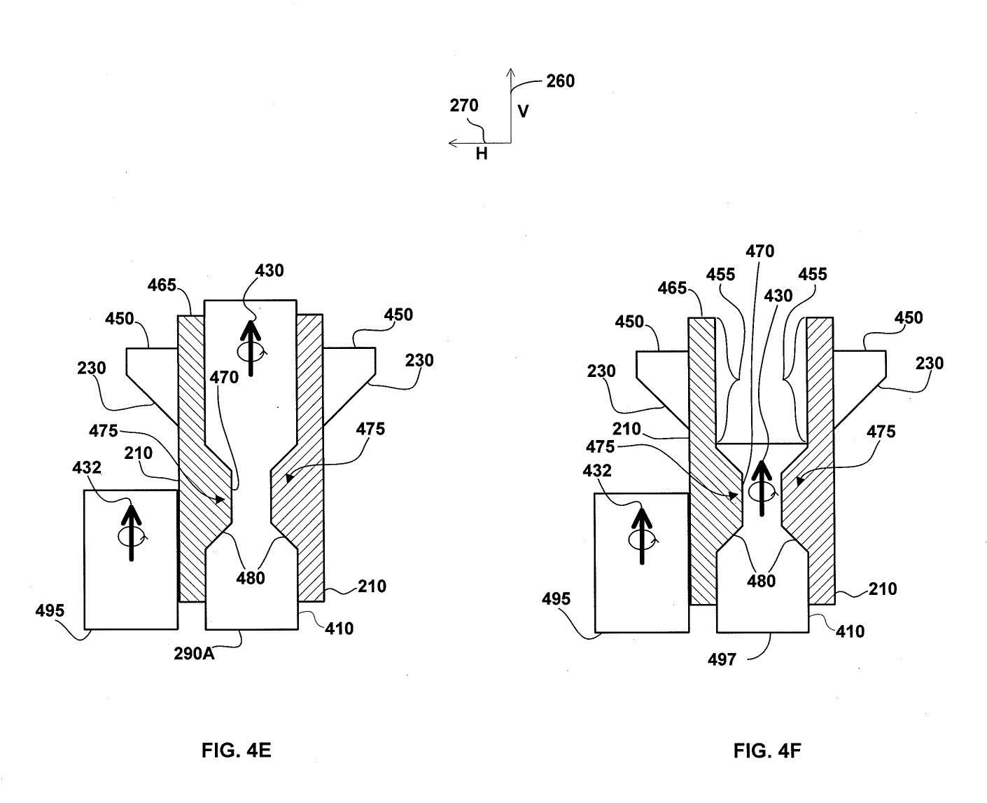

FIGS. 4A, 4B, 4C, and 4D illustrate cross-sectional views of alternative embodiments of First Vertical Belt 210, Support Protrusions 230, and Vertical Rollers 290A. It will be appreciated from the embodiments illustrated herein that many variations from the illustrated embodiments of First Vertical Belt 210, Support Protrusion 230, and Vertical Rollers 290A-290B are within the scope of this disclosure. In addition, Second Vertical Belt 220 and Vertical Rollers 290B are optionally configured identically to First Vertical Belt 210 and Vertical Rollers 290A.

FIG. 4A illustrates an instance of Vertical Rollers 290A including a Circular Surface 410 and a Support Surface 420. This instance of Vertical Rollers 290A is configured to rotate around a Vertical Rotational Axis 430 and to support First Vertical Belt 210 on Support Surface 420. Support Surface 420 is optionally tapered downward or upward toward an Outside Edge 440 of Vertical Rollers 290A, and optionally comprised of a low friction material such as Teflon™. Support Surface 420 carries the weight of First Vertical Belt 210 and, through Support Protrusions 230, the weight of FOUP 170. Vertical Rollers 290A may be configured to support First Vertical Belt 210 on two sides, as illustrated in FIG. 4A, or on a single side. For example, if different instances of Vertical Rollers 290A are used to support First Vertical Belt 210 as it returns in its looping path, then only one side of an instance of Vertical Rollers 290A may be used to support First Vertical Belt 210.

In typical embodiments, Support Protrusions 230 are configured for a FOUP 170 to rest on a Support Surface 450. Support Surface 450 is optionally curved in directions perpendicular and/or parallel to Vertical Surfaces 320. Support Surface 450 optionally includes a low friction coating (not shown). In some embodiments, Support Surface 450 is disposed a Distance 460 below an Upper Edge 465 of First Vertical Belt 210. As such, part of an article transported may be below part of First Vertical Belt 210. In various embodiments, Distance 460 is equal to or greater than zero, 10, 20, or 50 mm.

FIG. 4B illustrates a cross-sectional view of alternative embodiments of First Vertical Belt 210 and a member of Vertical Rollers 290A. In these embodiments, Vertical Rollers 290A include a notch or groove, such as a V-Groove 470, configured to receive a Part 475 of First Vertical Belt 210. V-Groove 470 includes a combined Circular/Support Surface 480 configured to support First Vertical Belt 210. In these embodiments, Support Surface 420 may not be required.

FIG. 4C illustrates a cross-sectional view of an alternative embodiment of First Vertical Belt 210 and Vertical Rollers 290A. These embodiments include an optional Capture Lip 485 and a Support 490. Typically, Capture Lip 485 is optionally included in other embodiments, such as those illustrated by FIGS. 4A and 4B. Capture Lip 485 is attached to First Vertical Belt 210 and is configured to restrict the vertical movement of FOUP 170. Capture Lip 485 is optionally connected to Support Protrusions 230. In alternative embodiments, Capture Lip 485 is attached to a separate, optionally stationary, support (not shown).

Support 490 is configured to support the weight of FOUP 170 through First Vertical Belt 210. In some embodiments, Support 490 includes a stationary low friction surface on which First Vertical Belt 210 is configured to slide. In some embodiments, Support 490 includes rolling elements such as ball bearings, or horizontally disposed rollers (not shown). These horizontally disposed rollers are optionally smaller and more closely spaced than Vertical Rollers 290A.

FIG. 4D illustrates a cross-sectional view of a Belt 415 and a member of Vertical Roller 290A. Belt 415 is an alternative embodiment of First Vertical Belt 210. In these embodiments, Belt 415 has a rounded (e.g., circular or elliptical) cross-section and Vertical Rollers 290A includes a Groove 425 configured to receive Belt 415. Because Belt 415 is round, long and short cross-sectional axes are not apparent. However, when Belt 415 is placed on Vertical Rollers 290A, Belt 415 still has vertical and horizontal axes that can be defined relative to the vertical and horizontal planes of the cross-section.

Belt 415, as well as First Vertical Belt 210 and Second Vertical Belts 220, optionally include a compliant material configured to reduce vibrations of an article being transported. In various embodiments, this compliant material can include urethane with a durometer hardness ranging between 25 A and 75 D, silicone, PVC (polyvinyl chloride), rubber, or the like. The compliant material reduces vibration by, for example, allowing vertical movement of an Edge 435 of Support Protrusions 230 distal to Belt 415. This movement may occur when an article is loaded or unloaded from Belt 415, when the force (e.g., weight) of an article on Support Surface 450 changes, or when Belt 415 is disposed in a curvilinear, inclined, or declined path. For example, if there is unevenness in the height of Belt 415 the force of an article on Support Surface 450 may change as an article is transported. In this instance, movement of Edge 435 or Support Surface 450 absorbs some of this change in force and Belt 415 acts as a shock absorber.

First Vertical Belt 210 and Second Vertical Belt 220 are optionally configured to reduce vibrations in a manner similar to that of Belt 415. For example, referring to FIG. 4A, First Vertical Belt 210 may include a compliant material that is configured to allow Upper Edge 465 to move away from First Vertical Rollers 290A when a FOUP 170 is loaded onto First Vertical Belt 210. This movement results in a movement of Support Surface 450. As FOUP 170 is transported, forces that may cause vibration may be absorbed by First Vertical Belt 210. The freedom of movement available to Upper Edge 465 allows First Vertical Belt 210 to act as a shock absorber.

FIGS. 4E and 4F illustrate alternative embodiments of First Vertical Belt 210 and members of Vertical Rollers 290A. The embodiments of Vertical Rollers 290A illustrated in FIGS. 4E and 4F comprise a Circular Surface 410 and a V-Groove 470 configured to receive a Part 475 of First Vertical Belt 210. V-Groove 470 includes a combined Circular/Support Surface 480 configured to support First Vertical Belt 210. In these embodiments, Support Surface 420 (FIG. 4A) and/or Support 490 (FIG. 4C) is not required. In these embodiments, Vertical Rollers 290A are configured to rotate around a Vertical Rotational Axis 430. The embodiments of First Vertical Belt 210 illustrated in FIGS. 4E and 4F comprise Support Protrusions 230 configured to support a FOUP 170 resting on a Support Surface 450.

In the embodiments of Vertical Roller 290A illustrated in FIG. 4E, Vertical Roller 290A is approximately as high in the Vertical Axis 260 as First Vertical Belt 210 and configured to provide lateral support to the First Vertical Belt 210 in the Horizontal Axis 270. In contrast, FIG. 4F illustrates a Short Vertical Roller 497 that is shorter than the First Vertical Belt 210 and configured to allow the First Vertical Belt 210 to flex in a direction of Horizontal Axis 270 within a Flexible Region 455. Short Vertical Roller 497 is an embodiment of Vertical Roller 290A. The flexibility of the First Vertical Belt 210 can be controlled by selecting a height of the Vertical Roller 290A or the Short Vertical Roller 497. For example, the flexibility of the First Vertical Belt 210 can be reduced by selecting the height of the Vertical Roller 290A to be similar to or greater than a height of the Upper Edge 465 of First Vertical Belt 210, as illustrated in FIG. 4E, and the flexibility of the First Vertical Belt 210 can be increased by selecting the height of the Vertical Roller 290A or the Short Vertical Roller 497 to be less than the height of the Upper Edge 465 of First Vertical Belt 210, as illustrated in FIG. 4F. The flexibility of the First Vertical Belt 210 may be varied within a conveyance section by including embodiments of Vertical Roller 290A having different heights within the conveyance section.

An optional Support Roller 495, as illustrated in FIGS. 4E and 4F, is configured to rotate about a Vertical Rotational Axis 432 and to maintain contact between the First Vertical Belt 210 and the Vertical Roller 290A in curved conveyance sections. For example, as illustrated elsewhere herein, a plurality of Vertical Rollers 290A may be configured to guide a First Vertical Belt 210 through a curved conveyance section. In a configuration comprising a first, second, and third Vertical Roller 290A disposed on the outside edge of a curved conveyance section, the First Vertical Belt 210 would naturally tend to pull away from a second (middle) Vertical Roller 290A to travel a shorter distance between the first Vertical Roller 290A and the third Vertical Roller 290A. A Support Roller 495 may be disposed on an opposite side of the First Vertical Belt 210 relative to the second Vertical Roller 290A to maintain contact between the second Vertical Roller 290A and the First Vertical Belt 210, and thereby maintain a curvilinear path of the First Vertical Belt 210 in the curved conveyance section.

As another example, a FOUP may exert pressure against a top portion of a First Vertical Belt 210 due to centrifugal or other forces as the FOUP turns about an axis of rotation. When Short Vertical Roller 497 is used, a bottom portion of the First Vertical Belt 210 may tilt away from the Vertical Roller 290A in a direction along a Horizontal Axis 270 as the top portion of the First Vertical Belt 210 tilts inward toward the center of the Vertical Roller 290A in an opposite direction along the Horizontal Axis 270. In order to prevent tilting away from Short Vertical Roller 497, the Support Roller 495 is optionally configured to hold the bottom portion of the First Vertical Belt 210 in place against the Short Vertical Roller 497.

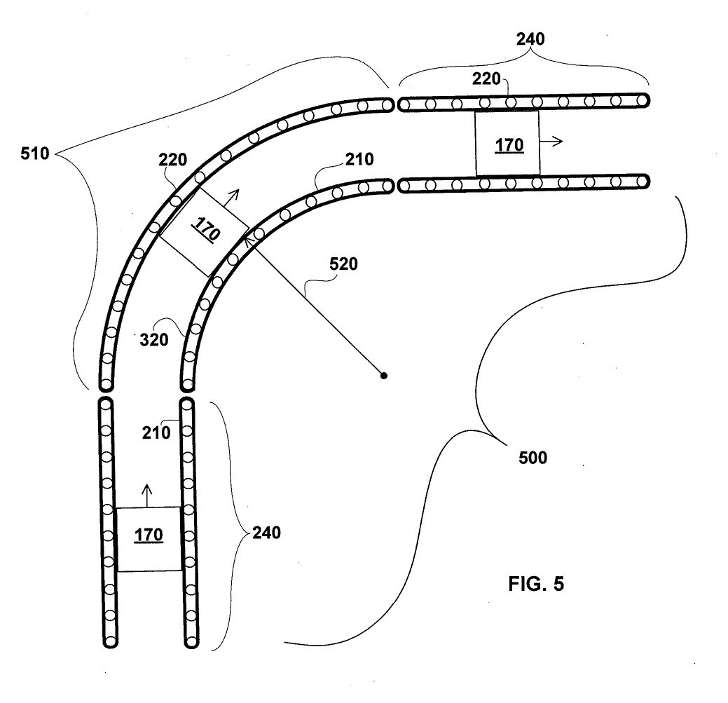

FIG. 5 illustrates an embodiment of Transport System 500 including a Transport Section 510 configured to form a curvilinear conveyance path. Transport Section 510 is optionally an embodiment of Transport Section 240. In various embodiments, an inner Vertical Surface 320 of First Vertical Belt 210 of Transport Section 510 is disposed in a Radius of Curvature 520 equal to, or less than, 2.0, 1.5 or 1.0 meters. In some embodiments, Transport Section 510 is banked. This may allow tighter radii of curvature. Within Transport Section 510, First Vertical Belt 210 is typically configured to run at a different speed than Second Vertical Belt 220. For example, in one embodiment, First Vertical Belt 210 is configured to move at a slower linear velocity than Second Vertical Belt 220. Thus, Transport Section 510 may include belts and rollers that run at different speeds while transporting FOUP 170.

Using Transport Section 510, FOUP 170 can be turned without slowing or without momentarily stopping. Thus, the direction of motion of FOUP 170 can be changed without slowing or without stopping. Further, more than one instance of FOUP 170 can be turned by Transport Section 510 at the same time. By arranging several Transport Section 510 and Transport Section 240 together, a complex variety of curvilinear and straight conveyance paths can be configured. In some embodiments, Transport Section 510 and/or Transport Section 240 are configured to change the elevation of FOUP 170 above the ground as FOUP 170 moves along a conveyance path.

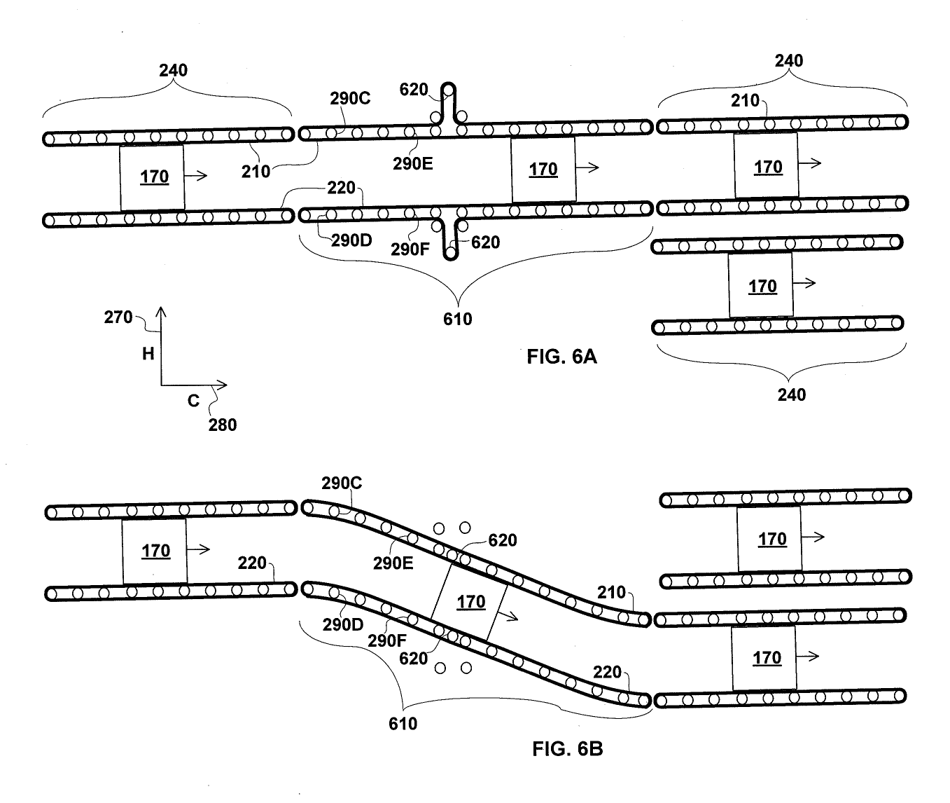

FIGS. 6A and 6B illustrate embodiments of Transport System 500 in two different dynamically interchangeable states. These embodiments include a Dynamic Transport Section 610 configured to change shape and, thus, convey FOUP 170 along alternative conveyance paths. FIG. 6A illustrates a first state in which Dynamic Transport Section 610 is disposed to convey FOUP 170 along a linear conveyance path from a first instance of Transport Section 240 to a second instance of Transport Section 240. FIG. 6B illustrates a second state in which Dynamic Transport Section 610 is disposed to convey FOUP 170 along a curvilinear conveyance path from the first instance of Transport Section 240 to a third instance of Transport Section 240. The transition between the first state and the second state may be performed automatically and is optionally performed while Dynamic Transport Section 610 is being used to transport FOUP 170. Thus, the change in state can be performed without stopping the transport of FOUP 170.

As shown in FIGS. 6A and 6B, the length of Dynamic Transport Section 610 can be different in the first state and the second state. Dynamic Transport Section 610 optionally includes one or more Tension Rollers 620 configured to maintain tension of First Vertical Belt 210 and Second Vertical Belt 220 as Dynamic Transport Section 610 changes length from the first state to the second state. Tension Rollers 620 are typically an embodiment of Vertical Rollers 290A. The change in shape of Dynamic Transport Section 610 shown in FIGS. 6A and 6B is possible, in part, because the required motion is in the Horizontal Axis 270 where First Vertical Belt 660 and Second Vertical Belt 670 are less stiff.

The change of Dynamic Transport Section 610 from the first state to the second state optionally includes concerted motion of Tension Rollers 620 and various instances of vertical rollers. For example, the state change may include the movement in the horizontal plane of Vertical Rollers 290C and 290D. If the movement occurs during transport of FOUP 170, the spacing between Vertical Rollers 290C and 290C may be appropriately maintained during movement. Likewise, the spacing between Vertical Rollers 290E and 290F may be appropriately maintained as they are moved to new positions. In order to create the curvilinear path illustrated in FIG. 6B, Vertical Rollers 290E and 290F are move a greater distance than Vertical Rollers 290C and 290D from their original position in FIG. 6A. Typically, movement of Vertical Rollers 290A-290F is managed by a computer controlled translation system (not shown). Vertical Rollers 290A-290F are embodiments of Vertical Rollers 290A and 290B, collectively referred to elsewhere herein as Vertical Rollers 290.

While FIGS. 6A and 6B illustrate the conveyance of instances of FOUP 170 from right to left, alternative embodiments may be configured for conveyance from left to right. Thus, Dynamic Transport Section 610 may be used to direct FOUP 170 to a selected member of a plurality of alternative destinations, or to receive FOUP 170 from a selected member of a plurality of alternative sources.

In some embodiments, Dynamic Transport Section 610 is configured to reorder the instances of FOUP 170 within Transport System 500. For example, Dynamic Transport Section 610 may be used to shift a front first FOUP 170 from a primary conveyance path to a secondary conveyance path that allows the first FOUP 170 to be passed by a second FOUP 170. The first FOUP 170 is then returned to the primary conveyance path using a second instance of Dynamic Transport Section 610 behind the second FOUP 170. This exchange of position can be performed while continuously moving both the first FOUP 170 and the second FOUP 170.

Transport Section 240 and Dynamic Transport Section 610 optionally include mechanisms configured to facilitate loading or unloading of FOUP 170. These mechanisms include, for example, a region in which Capture Lip 485 is absent, a region in which Capture Lip 485 is moved, a region in which First Vertical Belt 210 is bent or tilted, or a region in which First Vertical Belt 210 and/or Second Vertical Belt 220 are moved apart.

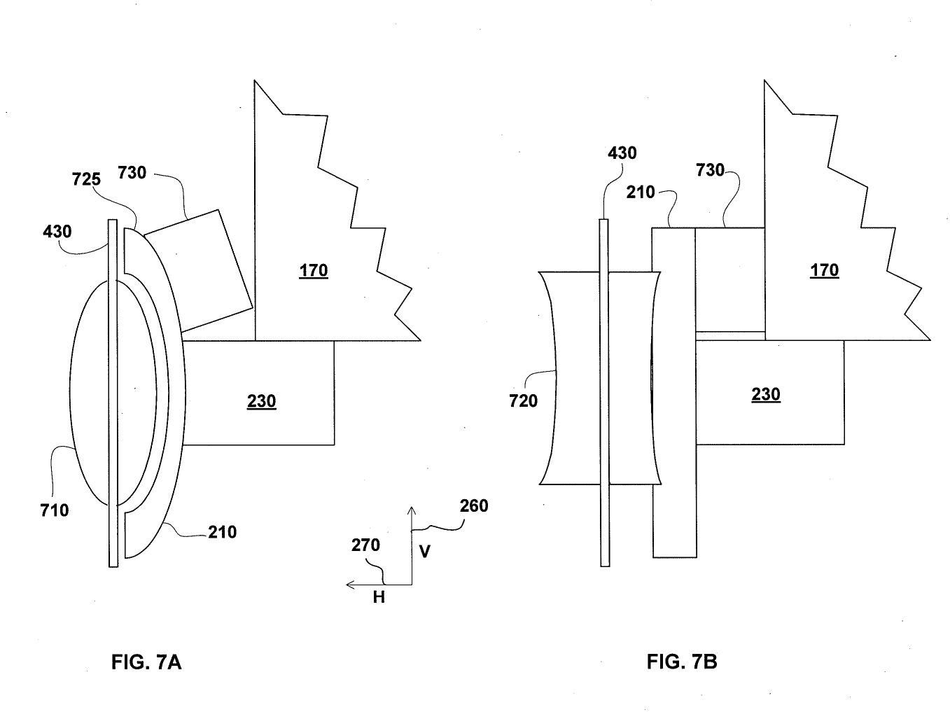

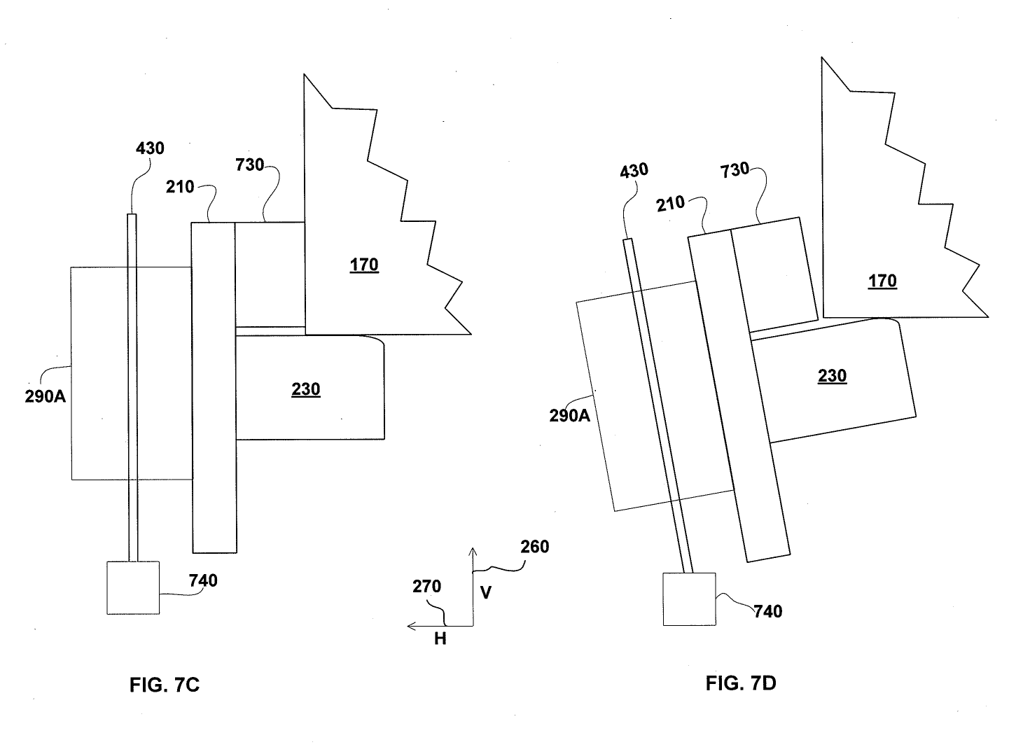

FIGS. 7A and 7B illustrate embodiments in which First Vertical Belt 210 is bent in Vertical Axis 260 in order to facilitate loading and/or unloading of FOUP 170. FIG. 7A illustrates First Vertical Belt 210 in a loading/unloading position. In this position, an Upper End 725 of First Vertical Belt 210 is bent toward Vertical Rotational Axis 430 of a Vertical Roller 710. Vertical Roller 710 is an embodiment of Vertical Roller 290A or 290B and is optionally convexly shaped in order to promote the bending of First Vertical Belt 210. When First Vertical Belt 210 is bent as illustrated in FIG. 7A, FOUP 170 is separated from a Capture Element 730.

Capture Element 730 is configured to apply pressure against a side of FOUP 170 in order to hold FOUP 170 securely between First Vertical Belt 210 and Second Vertical Belt 220. Capture Element 730 is typically a compliant material such as urethane. When Capture Element 730 is separated from FOUP 170, FOUP 170 can be loaded or unloaded from Transport System 500.

FIG. 7B illustrates First Vertical Belt 210 in a transport position. In this position, First Vertical Belt 210 is held straight by a Vertical Roller 720 and Capture Element 730 is applied to an edge of FOUP 170. Vertical Roller 710 and Vertical Roller 720 are optionally included in the same instance of Transport Section 240. Thus, First Vertical Belt 210 may be bent at some points within Transport Section 240 and be held straight at other points within Transport Section 240. Those points at which First Vertical Belt 210 is bent may be used for loading or unloading, while FOUP 170 is held securely between First Vertical Belt 210 and Second Vertical Belt 220 at those points at which First Vertical Belt 210 (and Second Vertical Belt 220) are held straight.

FIGS. 7C and 7D illustrate embodiments in which Vertical Rollers 290A and 290B are tilted in Vertical Axis 260 in order to facilitate loading and unloading of FOUP 170. FIG. 7C illustrates First Vertical Belt 210 and Vertical Roller 290A in a transport position, while FIG. 7D illustrates First Vertical Belt 210 and Vertical Roller 290A in a load/unload position. In the load/unload position, Vertical Roller 290A and Vertical Rotational Axis 430 is tilted relative to Horizontal Axis 270. This tilting shifts Capture Element 730 away from FOUP 170 and allows loading or unloading of FOUP 170. Tilting of Vertical Roller 290A or 290B is controlled by a mechanical or electromechanical Tilt Control Element 740. Typically, both Vertical Rollers 290A and Vertical Rollers 290B are tilted as illustrate in FIG. 7D in order to load or unload FOUP 170. These tilts are optionally in opposing directions.

While those embodiments illustrated by FIGS. 7A-7D include the use of Capture Element 730, in alternative embodiments, Capture Element 730 is replaced by Capture Lip 485. As with Capture Element 730, Capture Lip 485 is configured to limit movement of FOUP 170, e.g., preventing FOUP 170 from inadvertently disengaging from Transport Section 240. However, Capture Lip 485 is configured to limit primarily vertical movement and need not make physical contact with FOUP 170 during normal transport.

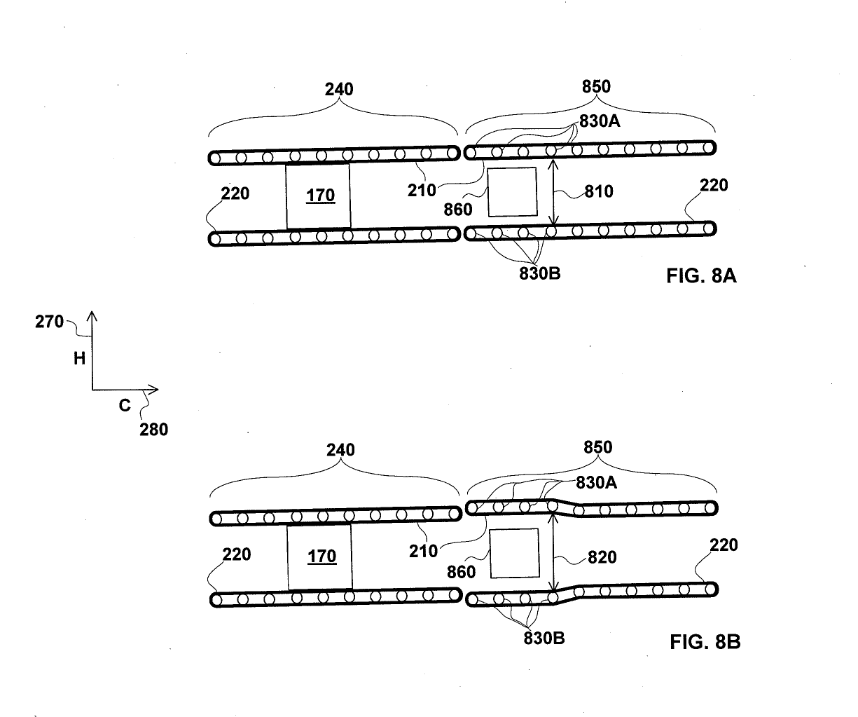

FIGS. 8A and 8B illustrate embodiments of Transport Sections 240 and 850 in which First Vertical Belt 210 and Second Vertical Belt 220 are moved apart in order to load or unload FOUP 170, optionally via a Three-point Kinematic Interface 860. FIG. 8A illustrates Transport Sections 240 and 850 in a normal transport mode used for conveying FOUP 170. In this mode, First Vertical Belt 210 and Second Vertical Belt 220 of Transport Section 850 are approximately a uniform Distance 810 from each other.

FIG. 8B illustrates Transport Sections 240 and 850 in a load/unload mode in which Vertical Rollers 830A and Vertical Rollers 830B and, thus, First Vertical Belt 210 and Second Vertical Belt 220 have been moved apart in Transport Section 850. Vertical Rollers 830A and 830B are embodiments of Vertical Rollers 290A and 290B, respectively. In the load/unload mode all or part of those instances of First Vertical Belt 210 and Second Vertical Belt 220 are a Distance 820 from each other. Distance 820 is typically greater than Distance 810. Distance 820 is sufficient to disengage Capture Element 730 from FOUP 170 or to allow FOUP 170 to clear Capture Lip 485. However, Distance 820 is optionally not so large that FOUP 170 is no longer supported by Support Protrusions 230. In various embodiments, Vertical Rollers 830A and 830B are disposed toward one end of Transport Section 850 or disposed elsewhere within Transport Section 850. Vertical Rollers 830A and 830B are moved from the positions shown in FIG. 8A to the positions shown in FIG. 8B by a mechanical or electromechanical control element.

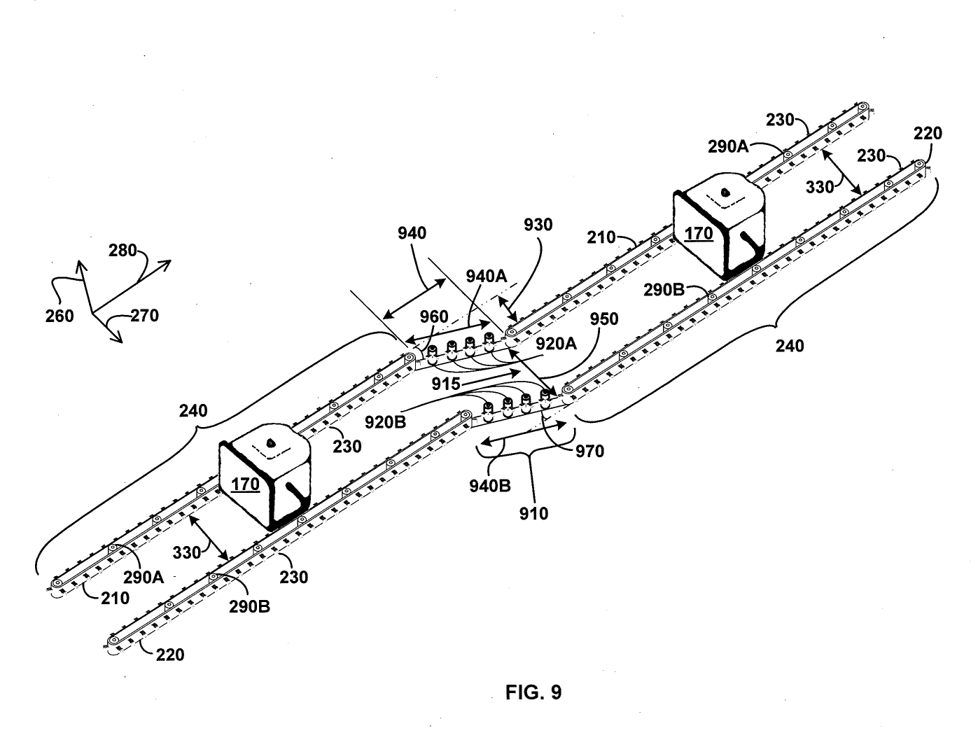

FIG. 9 illustrates an Offset Section 910 disposed between a first Transport Section 240 and a second Transport Section 240, according to various embodiments of the invention. The Offset Section 910 is typically configured to convey articles, such as the FOUP 170, from the first Transport Section 240 to the second Transport Section 240, the first Transport Section 240 and the second Transport Section 240 being separated by an Offset Section Length 940, and thus allow the articles to transition smoothly between the noncontiguous transport sections. Using the Offset Section 910, the direction of motion of the articles is optionally changed without slowing or momentarily stopping the articles. Typically, the Offset Section 910 is configured to provide an Offset Distance 930 along the Horizontal Axis 270 perpendicular to the Conveyance Direction 280 between a conveyance path of the first Transport Section 240 and a conveyance path of the second Transport Section 240. In various embodiments, the Offset Distance 930 is at least 100 mm and less than or equal to 150 mm, 200 mm, 240 mm, and 300 mm. In some embodiments, the Offset Distance 930 is greater than 300 mm, or is greater than or equal to the Offset Section Width 950.

In various embodiments, the Conveyance Direction 280 of the second Transport Section 240 is parallel or not parallel to the Conveyance Direction 280 of the first Transport Section 240. In various embodiments, the Offset Section 910 is disposed between a first transport section such as the Transport Section 240, the Transport Section 510, the Dynamic Transport Section 610, or the Transport Section 850, and a second transport section such as the Transport Section 240, the Transport Section 510, the Dynamic Transport Section 610, or the Transport Section 850, the first transport section and the second transport section optionally having different configurations from each other. The Offset Section 910 may also be disposed between any other transport sections capable of transporting the articles such as a FOUP 170. By arranging several Offset Sections 910 together with multiple instances of various transport sections, a complex variety of curvilinear and straight conveyance paths can be configured.

The Offset Section 910 is characterized by an Offset Section Width 950, a First Offset Angle 960, and a Second Offset Angle 970. Typically, the Offset Section Width 950 is configured to be approximately the same as the Distance 330 in the first Transport Section 240 from which the Offset Section 910 receives the FOUP 170, and approximately the same as the Distance 330 in the second Transport Section 240 to which the Offset Section 910 delivers the FOUP 170. The First Offset Angle 960 is a geometric angle measured between the Conveyance Direction 280 of the first Transport Section 240 and an Offset Section Conveyance Direction 915. The Second Offset Angle 970 is a geometric angle measured between the Offset Section Conveyance Direction 915 and the Conveyance Direction 280 of the second Transport Section 240. In embodiments where the Conveyance Direction 280 of the first Transport Section 240 is approximately equal to the Conveyance Direction 280 of the second Transport Section 240, the First Offset Angle 960 may be approximately equal in magnitude to the Second Offset Angle 970. In various embodiments, the First Offset Angle 960 is greater than zero and may be less than or equal to 1 degree, less than or equal to 2 degrees, less than or equal to 3 degrees, less than or equal to 4 degrees, less than or equal to 5 degrees, less than or equal to 20 degrees, less than or equal to 30 degrees, or less than or equal to 45 degrees.

The Offset Section 910 is typically configured to provide guidance to the articles as they are conveyed from the first transport section to the second transport section, and to turn the articles from being conveyed in the Conveyance Direction 280 of the first transport section, to being conveyed in the Offset Section Conveyance Direction 915, and finally to being conveyed in the Conveyance Direction 280 of the second transport section. In various embodiments, the Offset Section 910 comprises one or more Transition Wheels 920A and/or one or more Transition Wheels 920B. The Transition Wheels 920A and the Transition Wheels 920B are typically embodiments of vertical rollers that rotate to provide motion in the Offset Section Conveyance Direction 915. The Transition Wheels 920A are typically disposed along a first outside edge of the conveyance path following the First Vertical Belt 210 and the Vertical Rollers 290A of the first Transport Section 240. The Transition Wheels 920B are typically disposed along a second outside edge of the conveyance path following the Second Vertical Belt 220 and the Vertical Rollers 290B of the first Transport Section 240. In various embodiments, a First Offset Guidance Path Length 940A along the first outside edge of the conveyance path is less than, approximately equal to, or greater than a Second Offset Guidance Path Length 940B along the second outside edge of the conveyance path.

The Transition Wheels 920A may be separated from each other by a variety of distances. Likewise, the Transitions Wheels 920B may be separated from each other by a variety of distances. The spacing of the Transition Wheels 920A and the Transition Wheels 920B is optionally configured such that more than one Transition Wheels 920A and more than one Transition Wheels 920B provide support to the article being conveyed at the same time.

In various embodiments, the Offset Section 910 comprises only one Transition Wheel 920A and no Transition Wheels 920B, the Offset Section 910 comprises no Transition Wheels 920A and only one Transition Wheel 920B, or the Offset Section 910 comprises only one pair of Transition Wheels 920A and Transition Wheels 920B. In various embodiments, the one or more Transition Wheels 920A and the one or more Transition Wheels 920B are optionally driven separately or jointly. In various embodiments, the Transition Wheels 920A and the Transition Wheels 920B may comprise one or more support protrusions, one or more capture lips, and/or one or more capture elements. In some embodiments, the Transition Wheels 920A and Transition Wheels 920B include one or more of Short Vertical Roller 497.

In various embodiments, the Transition Wheels 920A and the Transition Wheels 920B are be substituted with one or more horizontal rollers, a section of one or more vertical belts with one or more supports, a section of one or more horizontal belts with one or more supports, or one or more vertical rollers with or without vertical belts. Horizontal rollers and horizontal belts are further described in U.S. Provisional Patent Application Ser. No. 60/840,169, which is hereby incorporated herein by reference.

The Transition Wheels 920A are typically spaced apart from the Transition Wheels 920B such that the article, such as the FOUP 170, may be guided between the Transition Wheels 920A and the Transition Wheels 920B. In various embodiments, the Transition Wheels 920A and the Transition Wheels 920B may be spaced apart from one another by the Offset Section Width 950 equal to or less than 390, 392, 400, 415, or 500 millimeters (mm). Thus, an instance of the FOUP 170 that is, for example, 390 mm wide has less than zero, 2, 10, 25, or 110 mm of lateral freedom of movement. In various other embodiments, the Offset Section Width 950 is between 2.35 and 2.6 meters (m) or between 2.1 and 2.3 m. Some embodiments of the invention includes a Three-point Kinematic Interface 860 as shown in FIG. 8 configured to locate a FOUP within this freedom of movement when the FOUP is unloaded from the Offset Section 910.

A path along which the Transition Wheels 920A and the Transition Wheels 920B are disposed defines a conveyance path through which the FOUP 170 travels. This conveyance path may be straight, curvilinear, inclined, declined, and/or dynamically variable. For example, in some embodiments, the Transition Wheels 920A and the Transition Wheels 920B are coupled to movable mounts and are configured to move between various different positions in order to change a conveyance path. In some embodiments, the Transition Wheels 920A and the Transition Wheels 920B are configured to move while conveying articles.

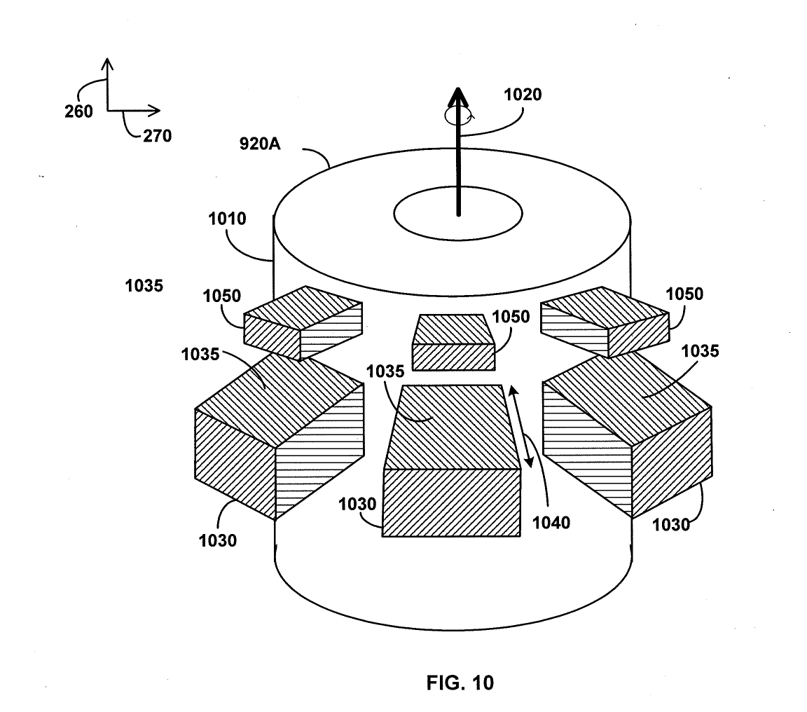

FIG. 10 illustrates Transition Wheels 920A, according to various embodiments of the invention. The Transition Wheel 920A comprises an approximately circular Surface 1010. The Transition Wheel 920A is typically configured to rotate about a Vertical Rotational Axis 1020. The Vertical Rotational Axis 1020 is optionally parallel to the Surface 1010.

The Transition Wheel 920A typically comprises a plurality of Support Protrusions 1030 extending approximately horizontally from the Vertical Rotational Axis 1020. The Support Protrusions 1030 include a Support Surface 1035 configured to support the weight of the articles such as the FOUP 170. The Support Surface 1035 may be disposed below a part of the Transition Wheel 920A. The weight of articles is transferred from the Support Protrusions 1030 to the Transition Wheel 920A. The Support Protrusions 1030 are typically configured to support the article to be conveyed, such as a FOUP 170, in the direction of the Vertical Axis 260. In various embodiments, the Support Protrusions 1030 may extend approximately parallel to the Horizontal Axis 270 by a Distance 1040 equal to or less than 5, 15, 25, or 30 mm from the Surface 1010.

In various embodiments, the Support Protrusions 1030 have shock absorbing properties. For example, the Support Protrusions 1030 may be configured to move or flex vertically when supporting the weight of the FOUP 170. The Support Protrusions 1030 may include a compliant material configured to reduce vibrations of the article being transported. This compliant material can include urethane, silicone, PVC (polyvinyl chloride), rubber, or the like. This compliant material may be characterized by a durometer hardness ranging between 25 A and 75 D. In some embodiments, the Support Protrusions 1030 include a low friction material such as Teflon™ that will allow an article to move slightly on the Support Protrusions 1030. In some embodiments, the Support Protrusions 1030 include a high friction material that reduces slippage during high acceleration, deceleration, or changes in directions of travel.

The Support Protrusions 1030 may be separated from one another by a variety of distances. In some embodiments, the Support Protrusions 1030 are essentially continuously connected in an approximately circular radius around the Vertical Rotational Axis 1020.

Some embodiments include an optional Retaining Lip 1050 configured to restrain movement of the articles to be conveyed relative to the transport system, and thus prevent tipping of the articles during acceleration, deceleration, and changes in the articles' direction of conveyance. The Retaining Lip 1050 is optionally part of the Support Protrusion 1030, a separate protrusion coupled to the Transition Wheel 920A, or attached to a stationary supporting structure. The Retaining Lips 1050 may be separated from one another by a variety of distances. In some embodiments, the Retaining Lips 1050 are essentially continuously connected in an approximately circular radius around the Vertical Rotational Axis 1020. The one or more Retaining Lips 1050 are optionally configured to apply pressure against a side of the FOUP 170 in order to hold FOUP 170 securely between the Transition Wheels 920A and the Transition Wheels 920B. In some embodiments, the one or more Retaining Lips 1050 comprise a compliant material. This compliant material can include urethane, silicone, PVC (polyvinyl chloride), rubber, or the like. In some embodiments, the one or more Retaining Lips 1050 include a low friction material such as Teflon™. This compliant material may be characterized by a durometer hardness ranging between 25A and 75D. In some embodiments, the one or more Retaining Lips 1050 include a high friction material that reduces slippage during high acceleration, deceleration, or changes in directions of travel.

One or more instances of the Transition Wheel 920A are optionally used elsewhere in the conveyor system to guide and/or support the articles to be conveyed.

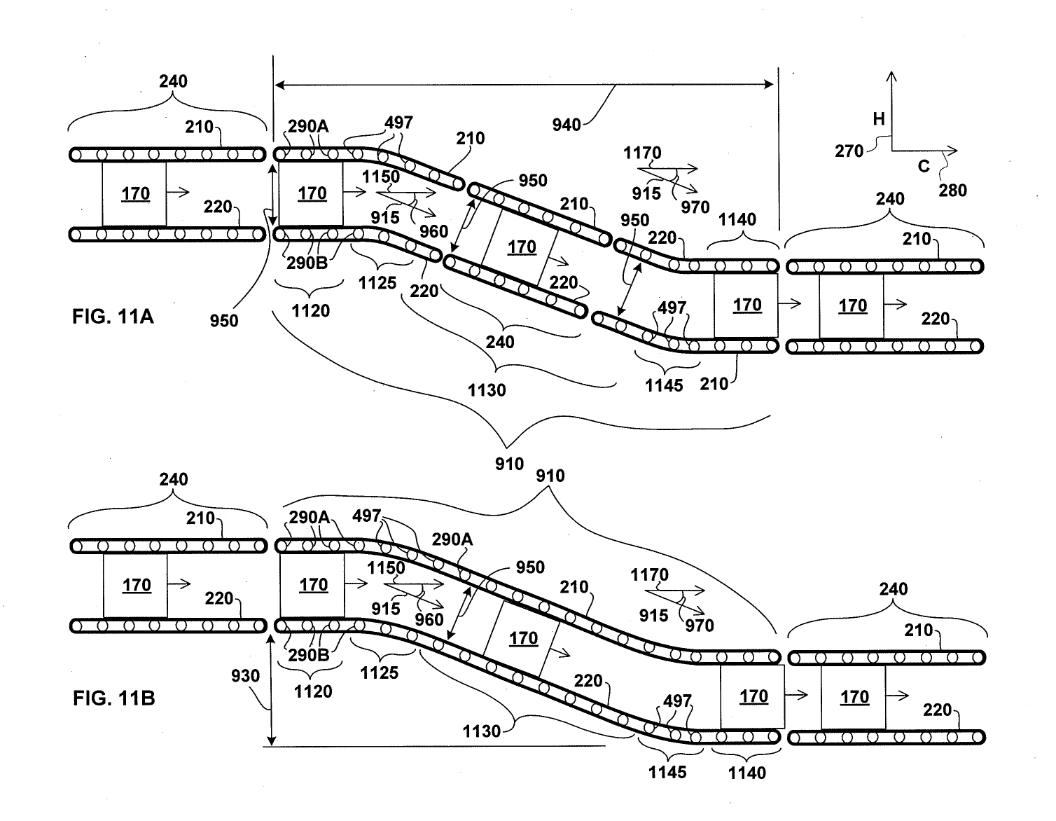

FIGS. 11A and 11B illustrate alternative embodiments of an Offset Section 910. Some embodiments of the Offset Section 910 as illustrated in FIG. 11A comprise a First Vertical Belt 210 and a Second Vertical Belt 220. The First Vertical Belt 210 and the Second Vertical Belt 220 are each driven separately or jointly in a conveyance direction by a plurality of Vertical Rollers 290A and a plurality of Vertical Rollers 290B, respectively. The First Vertical Belt 210 and the Second Vertical Belt 220 are typically separated by an Offset Section Width 950.

In some embodiments, as illustrated in FIG. 11A, a curvilinear conveyance path through the Offset Section 910 is formed by an Offset Section Entrance 1120, a First Curvilinear Offset Region 1125, an optional Offset Section Middle 1130, a Second Curvilinear Offset Region 1145, and an Offset Section Exit 1140. In some embodiments, the Offset Section Entrance 1120 is configured to transport a FOUP 170 in a Conveyance Direction 1150 until the FOUP 170 no longer contacts the First Transport Section 240. The First Curvilinear Offset Region 1125 is disposed between the optional Offset Section Middle 1130 and the Offset Section Entrance 1120. The First Curvilinear Offset Region 1125 is configured to change a conveyance direction of the FOUP 170 by a First Offset Angle 960 between the Conveyance Direction 1150 in the Offset Section Entrance 1120 and an Offset Section Conveyance Direction 915 in the Offset Section Middle 1130. The conveyance direction of the FOUP 170 may be changed gradually by a placement of a plurality of Vertical Rollers 290A and a plurality of Vertical Rollers 290B, each of which is configured to change the conveyance direction of the FOUP 170 by an incremental offset angle that is a fraction of the First Offset Angle 960.

In some embodiments, short vertical rollers such as Short Vertical Rollers 497 are configured to guide the First Vertical Belt 210 in the First Curvilinear Offset Region 1125 on an outside curved edge of the conveyance path through the First Curvilinear Offset Region 1125. The Short Vertical Rollers 497 are typically configured to allow the First Vertical Belt 210 to flex in response to pressure applied by the FOUP 170 as the FOUP 170 turns from the Conveyance Direction 1150 to the Offset Section Conveyance Direction 915. By flexing in response to pressure from the FOUP 170, the First Vertical Belt 210 supported by the Short Vertical Rollers 497 may turn the FOUP 170 more smoothly than embodiments without the Short Vertical Rollers 497.

In some embodiments, one or more optional Transport Sections 240 are disposed within the Offset Section Middle 1130. A Transport Section 240 may be configured to transport a FOUP 170 between the First Curvilinear Offset Region 1125 and the Second Curvilinear Offset Region 1145.

In some embodiments, a Second Curvilinear Offset Region 1145 is configured to transport a FOUP 170 between the Transport Section 240 and the Offset Section Exit 1140. The Second Curvilinear Offset Region 1145 is configured to change a conveyance direction of the FOUP 170 by a Second Offset Angle 970 between the Offset Section Conveyance Direction 915 and the Conveyance Direction 1170. The conveyance direction of the FOUP 170 may be changed gradually by a placement of a plurality of Vertical Rollers 290A and a plurality of Vertical Rollers 290B, each of which is configured to change the conveyance direction of the FOUP 170 by an incremental offset angle that is a fraction of the Second Offset Angle 970.

In some embodiments, short vertical rollers such as Short Vertical Rollers 497 are configured to guide the First Vertical Belt 210 in the Second Curvilinear Offset Region 1145 on an outside curved edge of the conveyance path through the Second Curvilinear Offset Region 1145.

In some embodiments, the Offset Section Exit 1140 is configured to transport a FOUP 170 between the Second Curvilinear Offset Region 1145 and the Transport Section 240 adjacent to the Offset Section Exit 1140.

In some embodiments, the First Curvilinear Offset Region 1125 is configured to transport the FOUP 170 to the Second Curvilinear Offset Region 1145 directly. In these embodiments, no Transport Section 240 is disposed between the First Curvilinear Offset Region 1125 and the Second Curvilinear Offset Region 1145. In some embodiments, there are no physical separations between the Offset Section Entrance 1120, the First Curvilinear Offset Region 1125, the optional Offset Section Middle 1130, the Second Curvilinear Offset Region 1145, and the Offset Section Exit 1140. In these embodiments, a single belt such as First Vertical Belt 210 may span a first edge of a conveyance path through the Offset Section 910 and/or a single belt such as Second Vertical Belt 220 may span a second edge of the conveyance path through the Offset Section 910, as illustrated in FIG. 11B.

In some embodiments, the First Curvilinear Offset Region 1125 and the Second Curvilinear Offset Region 1145 are combined into a single curvilinear offset region. In these embodiments, there is no Offset Section Middle 1130 disposed between the First Curvilinear Offset Region 1125 and the Second Curvilinear Offset Region 1145. In some embodiments, the Offset Section 910 may be separated in other ways, with each separate region or section having its own independent set of vertical belts on the outside edges of a conveyance path through the region or section. For example, the Offset Section Middle 1130, the First Curvilinear Offset Region 1125, and the Offset Section Entrance 1120 may share a common pair of vertical belts while the Second Curvilinear Offset Region 1145 and the Offset Section Exit 1140 may share a separate common pair of vertical belts. In another example, the Offset Section Entrance 1120, the First Curvilinear Offset Region 1125, and a first half of the Offset Section Middle 1130 may share a common pair of vertical belts while a second half of the Offset Section Middle 1130, the Second Curvilinear Offset Region 1145, and the Offset Section Exit 1140 may share a separate common pair of vertical belts. In some embodiments, horizontal rollers and horizontal belts may replace the vertical rollers and vertical belts illustrated and described within this specification and in U.S. Provisional Patent Application Ser. No. 60/840,169.

Support rollers such as Support Rollers 495 are typically disposed on an opposite side of a vertical belt such as First Vertical Belt 210 relative to a vertical roller such as Short Vertical Roller 497 to maintain contact between the vertical belt and the vertical roller. For clarity, these Support Rollers 495 are not shown in FIGS. 11A and/or 11B; however, they are shown elsewhere herein.

In some embodiments, the Offset Section 910 is configured to cause the First Vertical Belt 210 and the Second Vertical Belt 220 to move at different velocities relative to one another to transport the FOUP 170 along a conveyance path through the Offset Section 910. While the First Vertical Belt 210 and the Second Vertical Belt 220 are moving the FOUP 170 in a straight direction, the First Vertical Belt 210 and the Second Vertical Belt 220 are configured to move at a same velocity. While the First Vertical Belt 210 and the Second Vertical Belt 220 are turning the FOUP 170 such as in a First Curvilinear Offset Region 1125 and/or a Second Curvilinear Offset Region 1145, one or both of the First Vertical Belt 210 and the Second Vertical Belt 220 may be configured to change velocity such that the vertical belt on the outside edge of the curve moves at a higher linear velocity than the vertical belt on the inside edge of the curve.

The linear velocity of the First Vertical Belt 210 and the Second Vertical Belt 220 may be independently controlled based on a position of the FOUP 170 within the conveyance path. For example, Offset Section 910 may be configured such that as a FOUP 170 enters the Offset Section Entrance 1120 as illustrated in FIG. 11B, both the First Vertical Belt 210 and the Second Vertical Belt 220 are typically moving at the same linear velocity. As the FOUP 170 enters the First Curvilinear Offset Region 1125, the Second Vertical Belt 220 optionally slows down relative to the First Vertical Belt 210. To achieve this difference in speed, either belt may change velocity. As the FOUP 170 enters a straight section in the Offset Section Middle 1130, the Second Vertical Belt 220 again matches the linear velocity of the First Vertical Belt 210. As the FOUP 170 enters the Second Curvilinear Offset Region 1145, the First Vertical Belt 210 slows down relative to the Second Vertical Belt 220. As the FOUP 170 enters the Offset Section Exit 1140, the First Vertical Belt 210 again matches the linear velocity of the Second Vertical Belt 220. Intelligent control of the relative velocities of the First Vertical Belt 210 and the Second Vertical Belt 220 causes the linear velocities of the vertical belts to be well-matched with the linear velocities of the respective adjacent sides of the FOUP 170 as the vertical belts turn the FOUP 170 through curved conveyance sections such as those within the Offset Section 910. Some embodiments of the invention include sensors configured to detect the position of an article within Offset Section 910.

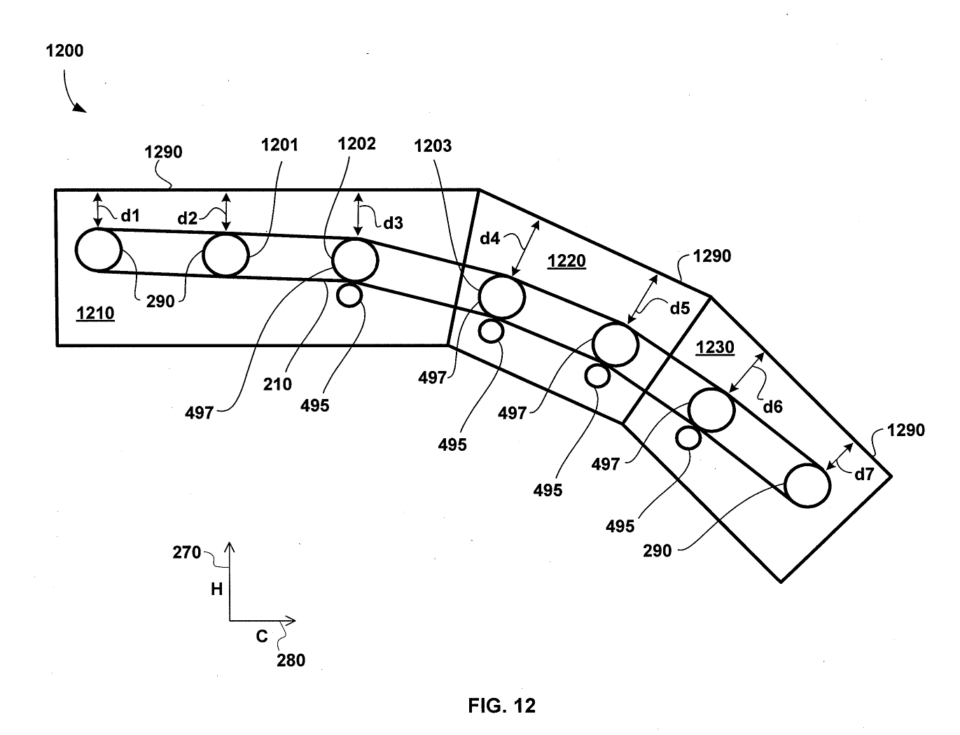

FIG. 12 illustrates part of a Support System 1200 for the Offset Section 910 according to various embodiments. Support structures such as Support Structures 1210, 1220, and 1230 are configured to support vertical rollers such as First Vertical Rollers 290A, Second Vertical Rollers 290B, and Short Vertical Rollers 497. Each support structure is a piece of material mechanically connected to one or more adjacent support structure. These connections may include a weld, bolts, guide pins, clips, and/or the like. In some embodiments the support structures are relatively straight pieces connected to each other at an angle. Optionally, the support structures include one or more positioning surfaces configured to position Support System 1200 relative to other parts of a transport system.

The vertical rollers supported by Support Structures 1210, 1220 and 1230 are disposed along an outside or inside edge of a conveyance path through an Offset Section 910 to define a curvilinear path. The vertical rollers are disposed at varying distances from an Outside Edge 1290 of the Support System 1200 such as Distances d1, d2, d3, d4, d5, d6, and d7. In some embodiments, Support System 1200 includes at least three rollers configured to support a vertical belt and has at least two more rollers than support structures. By having more rollers than support structures, the curvature of the vertical belt can be smoother than the curvature of the support structures.

In some embodiments, Support System 1200 is provided as a field replaceable unit configured to be installed into a transport system as a single component using the positioning surfaces. The field replaceable unit is configured to be replaced as a self-contained sub-assembly. The field replaceable unit optionally includes one or more indicating surfaces configured for positioning Support System 1200 within a transport system. These indicating surfaces may include pins, holes, edges, surfaces, corners, and/or the like configured to match to a mount.

Support structures such as Support Structures 1210, 1220, and 1230 may be configured to support vertical rollers within any portion of the Offset Section 910, Transport Section 240, Transport Section 510, Dynamic Transport Section 610, Transport Section 850, or the like. Support structures such as Support Structures 1210, 1220, and 1230 may be configured to support horizontal rollers, vertical wheels, horizontal wheels, and other support structures configured to support and/or transport an article as described elsewhere herein.

As illustrated in FIG. 12, Support Rollers 495 may be disposed against a side of a vertical belt, such as First Vertical Belt 210, opposite a vertical roller such as Vertical Roller 290. These Support Rollers 495 are configured to maintain contact between the First Vertical Belt 210 and the Vertical Roller 290 in a curved conveyance section. For example, in a configuration comprising three vertical rollers such as Vertical Rollers 1201, 1202, and 1203 in a curved conveyance section, the First Vertical Belt 210 could pull away from the second Vertical Roller 1202 to travel a straighter path between the first Vertical Roller 1201 and the third Vertical Roller 1203. A Support Roller 495 may be disposed on an opposite side of the First Vertical Belt 210 relative to the second Vertical Roller 1202 to prevent this from occurring and maintain contact between the second Vertical Roller 1202 and the First Vertical Belt 210.

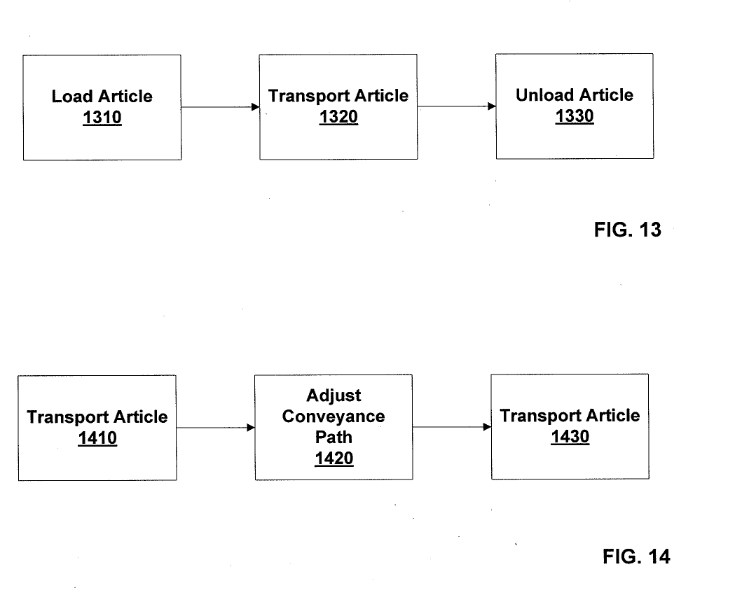

FIG. 13 illustrates methods of conveying articles, according to various embodiments. In these methods, an article is loaded onto a transport system such as those describe elsewhere herein, transported and unloaded. In a Load Article Step 1310, articles to be conveyed are placed on a transport section such as Transport Sections 240 or 850. The articles are optionally placed at a section of Transport Section 240 specifically configured for loading and unloading articles. For example, a FOUP 170 including semiconductor wafers may be loaded at a loading point discussed in relation to FIGS. 7A-7D, 8A, or 8B. The transport section on which articles are placed includes Vertical Rollers 290A and 290B, and optionally First Vertical Belt 210 and Second Vertical Belt 220. The weight of the placed article is not necessarily supported by Circular Surface 410, or Vertical Rollers 290A or 290B. The weight of the placed article is, therefore, optionally decoupled from Vertical Rollers 290A and 290B.

In a Transport Article Step 1320, the article loaded in Load Article Step 1310 is conveyed in a conveyance direction using Vertical Rollers 290A and 290B. This conveyance is optionally performed at a greater speed and/or a lower vibration rate than is possible in systems of the prior art. Transport Article Step 1320 optionally includes directing the article along a curvilinear path such as that illustrated in FIG. 5. The curvilinear path is optionally traversed without slowing or without momentarily stopping the article.

In an Unload Article Step 1330, the article is removed from the transport system. This removal optionally occurs at a location configured for loading and/or unloading of the article, as discussed elsewhere herein. Load Article Step 1310 and/or Unload Article Step 1330 optionally include changing the shape of First Vertical Belt 210 as illustrated in FIGS. 7A and 7B, tilting Vertical Rollers 290A or 290B as illustrated in FIGS. 7C and 7D, or moving Vertical Rollers 290A and 290B apart as illustrated in FIGS. 8A and 8B.

FIG. 14 illustrates methods of dynamically changing a conveyance path, according to various embodiments of the invention. The methods illustrated in FIG. 14 are optionally performed using the systems illustrated in FIGS. 6A and 6B during Transport Article Step 1320 (FIG. 13).

In a Transport Article Step 1410, an article, such as FOUP 170, is transported as in Transport Article Step 1320. In an Adjust Conveyance Path Step 1420, a conveyance path for the article is changed by moving Vertical Rollers 290A or 290B. This movement may be in the horizontal or vertical plane. In some embodiments, a Tension Roller 620 is used to adjust tension of a vertical belt coupled to Vertical Rollers 290A or 290B. The tension adjustment may be made before, during or after moving Vertical Rollers 290A or 290B. In some embodiments, the movement of Vertical Rollers 290A or 290B is performed while these rollers are conveying a FOUP. In a Transport Article Step 1430, the article is again conveyed, as in Transport Article Step 1320 or Transport Article Step 1410.

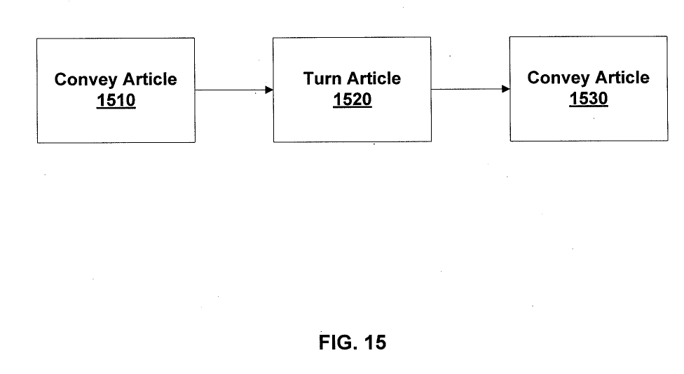

FIG. 15 illustrates methods of changing the conveyance path of articles, according to various embodiments. These methods may be used to convey articles in a curvilinear path between a first transport section and a second transport section, to change the direction of motion of the articles without slowing and/or momentarily stopping the articles, and provide an offset between the conveyance path of the first transport section and the conveyance path of the second transport section.

In a Convey Article Step 1510, an article is conveyed in a first conveyance section, such as Transport Section 240. The first conveyance section comprises a first belt disposed on a first side of a first conveyance path and a second belt disposed on second side of the first conveyance path. The first and second belt may be horizontal and/or vertical, and are configured to convey an article along the first conveyance path.

In a Turn Article Step 1520, the article is turned a second conveyance section, such as Offset Section 910. The article may be turned once or twice. When turned twice, the article may be conveyed on a path parallel to a previous conveyance path at an offset. The second conveyance section is configured to receive the article from the first conveyance section and comprises a third belt disposed on a first side of a curved conveyance path and a fourth belt disposed on second side of the curved conveyance path. The third belt and the fourth belt configured to convey the article along the curved conveyance path. Optionally, the second conveyance section further comprises a plurality of support protrusions attached to the third belt and the fourth belt and configured to support the article.

In a Convey Article Step 1530, the article is conveyed in a third conveyance section, such as Transport Section 240. The third conveyance section is configured to receive the article from the second conveyance section and comprises a fifth belt disposed on a first side of a second conveyance path and a sixth belt disposed on second side of the second conveyance path. The fifth belt and the sixth belt may be vertical and/or horizontal belts and are configured to convey the article along the second conveyance path. The fifth belt and the sixth belt may be any of the belts discussed elsewhere herein.

Several embodiments are specifically illustrated and/or described herein. However, it will be appreciated that modifications and variations are covered by the above teachings and within the scope of the appended claims without departing from the spirit and intended scope thereof. For example, while the transportation of FOUPs in semiconductor manufacturing have been used herein as an illustrative example, systems and methods of the invention may be configured for transporting alternative materials, such as for example, substrates for the manufacture of liquid crystal, organic light emitting diode or other types of display devices, for transporting substrates for memory devices such as optical disks or magnetic hard drive platters, for transporting substrates for photovoltaic devices, for transporting materials for manufacture of a battery, fuel cell or other power source; or the like. In embodiments configured for transporting substrates for the manufacture of liquid crystal, organic light emitting diode or other types of display devices, the Offset Section Width 950 may be between 2.35 and 2.6 m or between 2.1 and 2.3 m. Further, the vertical rollers and vertical belts discussed herein need not be perfectly vertical. The spacing of vertical rollers as illustrated herein is for illustrative purposes only. In various embodiments, vertical rollers may be disposed in a wide variety of spacings, from closely packed to widely dispersed including a single roller or rollers located only at each end of a belt. Some embodiments of the invention include both horizontal and vertical belts in the same conveyance section. For example, an outside edge of a curve may include a vertical belt while the inside edge includes a horizontal belt.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A system comprising:
a first conveyance section comprising a first belt disposed on a first side of a first conveyance path and a second belt disposed on second side of the first conveyance path, the first belt and the second belt configured to convey an article along the first conveyance path;
a second conveyance section configured to receive the article from the first conveyance section and comprising a third belt disposed on a first side of a curved conveyance path and a fourth belt disposed on second side of the curved conveyance path, the third belt and the fourth belt configured to convey the article along the curved conveyance path, the second conveyance section further comprising a plurality of support protrusions attached to the third belt and the fourth belt and configured to support the article; and
a third conveyance section configured to receive the article from the second conveyance section and comprising a fifth belt disposed on a first side of a second conveyance path and a sixth belt disposed on second side of the second conveyance path, the fifth belt and the sixth belt configured to convey the article along the second conveyance path.

2. The system of claim 1, further including the article, the article including a Front Opening Unified Pod (FOUP) or a semiconductor wafer.

3. The system of claim 1, further including the article, the article including a substrate used for manufacturing a display device.

4. The system of claim 1, further including the article, the article including a substrate for a memory device, a substrate for a photovoltaic devices, or a substrate for a power source.

5. The system of claim 1, wherein the second conveyance section includes at least three rollers configured to support the third belt.

6. The system of claim 5, wherein a first of the at least three rollers and a second of the at least three rollers have a different height.

7. The system of claim 5, wherein a first of the at least three rollers is configured to allow the third belt to flex by a greater amount than a second of the at least three rollers.

8. The system of claim 1, wherein the third belt is a vertical belt and the second conveyance section includes at least three vertical rollers configured to support the third belt.

9. The system of claim 1, wherein the second conveyance section is configured such that the third belt can flex by different amounts in different positions.

10. The system of claim 1, wherein the second conveyance section is configured to turn the article by between zero and four degrees.

11. The system of claim 1, wherein the article has less than 110 millimeters of freedom of movement perpendicular to a conveyance direction of the article in the second conveyance section.

12. The system of claim 1, wherein a relative velocity of the third belt and the fourth belt are configured to change as the article is conveyed through the second conveyance section.

13. The system of claim 1, wherein the third belt is part of a field replaceable unit, the field replaceable unit including at least three rollers configured to support the third belt and a set of support structures, the field replaceable having at least two more rollers than support structures.

14. The system of claim 1, wherein the third belt and the fourth belt are disposed less than 400 millimeters apart.

15. The system of claim 1, wherein the third belt and the fourth belt are disposed between 2.35 and 2.6 meters or between 2.1 and 2.3 meters apart.

16. The system of claim 1, wherein the third belt has a durometer hardness between 25A and 75D.

17. The system of claim 1, wherein the second conveyance section includes both curved and straight regions.

18. The system of claim 1, wherein part of the second conveyance section is inclined, declined or banked.

19. A system comprising:
a first conveyance section comprising a first belt disposed on a first side of a first conveyance path and a second belt disposed on second side of the first conveyance path, the first belt and the second belt configured to convey an article along the first conveyance path;
a second conveyance section configured to receive the article from the first conveyance section and comprising one or more transition wheels disposed on one or both sides of a conveyance path and configured to change a direction of travel of the article along the conveyance path, the one or more transitions wheels including support protrusions configured to support the article; and
a third conveyance section configured to receive the article from the second conveyance section and comprising a third belt disposed on a first side of a second conveyance path and a fourth belt disposed on second side of the second conveyance path, the third belt and the fourth belt configured to convey the article along the second conveyance path.

20. The system of claim 19, wherein the change in direction is between 0 and 3 degrees.

21. A system comprising:
a first conveyance section configured to receive an article and comprising a first belt disposed on a first side of a curved conveyance path and a second belt disposed on second side of the curved conveyance path, the first belt and the second belt configured to convey the article along the curved conveyance path, the first conveyance section further comprising a plurality of support protrusions attached to the first belt and the second belt and configured to support the article.

22. The system of claim 21, further comprising a second conveyance section configured to receive the article from the first conveyance section and comprising a third vertical belt disposed on a first side of a second conveyance path and a fourth belt disposed on second side of the second conveyance path, the third vertical belt and the fourth belt configured to convey the article along the second conveyance path.

23. The system of claim 21, wherein the first belt is a horizontal belt.

24. The system of claim 21, wherein the first belt is a vertical belt.

25. A method comprising:
conveying an article in a first conveyance section, the first conveyance section comprising a first belt disposed on a first side of a first conveyance path and a second belt disposed on second side of the first conveyance path, the first belt and the second belt configured to convey an article along the first conveyance path;
turning the article in a second conveyance section, the second conveyance section configured to receive the article from the first conveyance section and comprising a third belt disposed on a first side of a curved conveyance path and a fourth belt disposed on second side of the curved conveyance path, the third belt and the fourth belt configured to convey the article along the curved conveyance path, the second conveyance section further comprising a plurality of support protrusions attached to the third belt and the fourth belt and configured to support the article; and
conveying the article in a third conveyance section, the third conveyance section configured to receive the article from the second conveyance section and comprising a fifth belt disposed on a first side of a second conveyance path and a sixth belt disposed on second side of the second conveyance path, the fifth belt and the sixth belt configured to convey the article along the second conveyance path.

26. A semiconductor article manufactured by:
conveying the article in a first conveyance section, the first conveyance section comprising a first belt disposed on a first side of a first conveyance path and a second belt disposed on second side of the first conveyance path, the first belt and the second belt configured to convey an article along the first conveyance path;
turning the article in a second conveyance section, the second conveyance section configured to receive the article from the first conveyance section and comprising a third belt disposed on a first side of a curved conveyance path and a fourth belt disposed on second side of the curved conveyance path, the third belt and the fourth belt configured to convey the article along the curved conveyance path, the second conveyance section further comprising a plurality of support protrusions attached to the third belt and the fourth belt and configured to support the article; and
conveying the article in a third conveyance section, the third conveyance section configured to receive the article from the second conveyance section and comprising a fifth belt disposed on a first side of a second conveyance path and a sixth belt disposed on second side of the second conveyance path, the fifth belt and the sixth belt configured to convey the article along the second conveyance path.
